(19) United States
(12) Patent Application Publication
(10) Pub. No.: US 2026/0122507 A1
(43) Pub. Date: Apr. 30, 2026

(54) COORDINATED SPATIAL REUSE IN WI-FI

(71) Applicant: QUALCOMM Incorporated, San Diego, CA (US)

(72) Inventors: Sameer VERMANI, San Diego, CA (US); Jialing Li CHEN, San Diego, CA (US); Bin TIAN, San Diego, CA (US); George CHERIAN, San Diego, CA (US); Abhishek Pramod PATIL, San Diego, CA (US); Sherief HELWA, San Diego, CA (US)

(21) Appl. No.: 18/929,364

(22) Filed: Oct. 28, 2024

(51) Int. Cl. H04W 16/14; H04W 74/08

(52) U.S. Cl. CPC H04W 16/14; H04W 74/08

(57) ABSTRACT

This disclosure provides methods, components, devices and systems for coordinated spatial reuse in Wi-Fi, such as a coordinated beamforming (COBF) transmission mode or a coordinated spatial reuse (C-SR) transmission mode. Some aspects more specifically relate to a sharing access point (AP) and shared AP exchanging communications that facilitate the utilization of a transmission mode. In some implementations, a first AP may transmit, to a second AP, a message that includes first information associated with coordinated transmissions in which the first AP and the second AP concurrently transmit to one or more associated stations (STAs). The first information may include one or more of transmit power information for the coordinated transmissions, alignment information for the coordinated transmissions, or a transmission mode. The first AP and the second AP may proceed with coordinated communications within a shared transmission opportunity using the COBF transmission mode or the C-SR transmission mode.

### TECHNICAL FIELD

This disclosure relates generally to wireless communication and, more specifically, to coordinated spatial reuse in Wi-Fi.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communications by a first access point. The method may include receiving, from one or more first stations, channel parameters associated with at least a second access point, the first access point and the second access point having overlapping coverage areas, transmitting, to the second access point, first information associated with coordination of resources of a transmission opportunity, the first information associated with communications between one or more first stations and the first access point during the transmission opportunity, and transmitting, to the one or more first stations during the transmission opportunity in accordance with the first information, one or more messages using a transmission mode from a set of transmission modes including a coordinated spatial reuse transmission mode and a coordinated beamforming transmission mode.

Another innovative aspect of the subject matter described in this disclosure can be implemented in a first access point for wireless communications is described. The first access point may include a processing system that includes processor circuitry and memory circuitry that stores code. The processing system may be configured to cause the first access point to receive, from one or more first stations, channel parameters associated with at least a second access point, the first access point and the second access point having overlapping coverage areas, transmit, to the second access point, first information associated with coordination of resources of a transmission opportunity, the first information associated with communications between one or more first stations and the first access point during the transmission opportunity, and transmit, to the one or more first stations during the transmission opportunity in accordance with the first information, one or more messages using a transmission mode from a set of transmission modes including a coordinated spatial reuse transmission mode and a coordinated beamforming transmission mode.

Another innovative aspect of the subject matter described in this disclosure can be implemented in a first access point for wireless communications. The first access point may include means for receiving, from one or more first stations, channel parameters associated with at least a second access point, the first access point and the second access point having overlapping coverage areas, means for transmitting, to the second access point, first information associated with coordination of resources of a transmission opportunity, the first information associated with communications between one or more first stations and the first access point during the transmission opportunity, and means for transmitting, to the one or more first stations during the transmission opportunity in accordance with the first information, one or more messages using a transmission mode from a set of transmission modes including a coordinated spatial reuse transmission mode and a coordinated beamforming transmission mode.

Another innovative aspect of the subject matter described in this disclosure can be implemented in a non-transitory computer-readable medium storing code for wireless communications. The code may include instructions executable by one or more processors to receive, from one or more first stations, channel parameters associated with at least a second access point, the first access point and the second access point having overlapping coverage areas, transmit, to the second access point, first information associated with coordination of resources of a transmission opportunity, the first information associated with communications between one or more first stations and the first access point during the transmission opportunity, and transmit, to the one or more first stations during the transmission opportunity in accordance with the first information, one or more messages using a transmission mode from a set of transmission modes including a coordinated spatial reuse transmission mode and a coordinated beamforming transmission mode.

In some examples of the method, first access points, and non-transitory computer-readable medium described herein, the first information includes one or more first identifiers associated with communications between one or more first stations and the first access point during the transmission opportunity and the method, first access points, and non-transitory computer-readable medium may include further operations, features, means, or instructions for receiving, from the second access point, second information associated with the coordination of the resources that indicates whether the second access point can communicate with the one or more second stations during the transmission opportunity in accordance with the first information.

In some examples of the method, first access points, and non-transitory computer-readable medium described herein, the channel parameters include one or more channel condition reports that include a cross-BSS channel measurement based on a bandwidth resolution associated with transmissions of the second access point received from the one or more first stations.

Some examples of the method, first access points, and non-transitory computer-readable medium described herein may further include operations, features, means, or instructions for transmitting a first message of a coordinated sounding procedure, receiving sounding feedback for a cross-BSS channel link from the second access point to one or more first stations responsive to the first message, and selecting, in accordance with the sounding feedback, a multi-access point coordination scheme for use by the first access point and the second access point during the transmission opportunity, the multi-access point coordination scheme selected from a coordinated beamforming (COBF) scheme, a coordinated spatial reuse (C-SR) scheme, or a joint transmission (JT) scheme.

Another innovative aspect of the subject matter described in this disclosure can be implemented in a method for wireless communications by a first access point. The method may include transmitting, to a second access point, first information associated with coordinated spatial reuse of resources of a transmission opportunity that provides for communications between the first access point and one or more first stations during the transmission opportunity and communications between the second access point and one or more second stations during the transmission opportunity, the first information including one or more of a channel quality threshold for communications with the one or more first stations during the transmission opportunity, an absolute transmit power of the second access point or both an absolute transmit power of the first access point and an absolute transmit power of the second access point normalized to a unit of bandwidth associated with the transmission opportunity, a relative transmit power normalized to a unit of bandwidth of the second access point relative to a reference frame transmitted by the second access point or both a relative transmit power of normalized to a unit of bandwidth the first access point and a relative transmit power normalized to a unit of bandwidth of the second access point relative to a reference frame transmitted by a corresponding access point, or an identifier of the reference frame and communicating with one or more first stations during the transmission opportunity in accordance with the first information.

Another innovative aspect of the subject matter described in this disclosure can be implemented in a first access point for wireless communications. The first access point may include a processing system that includes processor circuitry and memory circuitry that stores code. The processing system may be configured to cause the first access point to transmit, to a second access point, first information associated with coordinated spatial reuse of resources of a transmission opportunity that provides for communications between the first access point and one or more first stations during the transmission opportunity and communications between the second access point and one or more second stations during the transmission opportunity, the first information including one or more of a channel quality threshold for communications with the one or more first stations during the transmission opportunity, an absolute transmit power of the second access point or both an absolute transmit power of the first access point and an absolute transmit power of the second access point normalized to a unit of bandwidth associated with the transmission opportunity, a relative transmit power normalized to a unit of bandwidth of the second access point relative to a reference frame transmitted by the second access point or both a relative transmit power of normalized to a unit of bandwidth the first access point and a relative transmit power normalized to a unit of bandwidth of the second access point relative to a reference frame transmitted by a corresponding access point, or an identifier of the reference frame and communicate with one or more first stations during the transmission opportunity in accordance with the first information.

Another innovative aspect of the subject matter described in this disclosure can be implemented in a first access point for wireless communications. The first access point may include means for transmitting, to a second access point, first information associated with coordinated spatial reuse of resources of a transmission opportunity that provides for communications between the first access point and one or more first stations during the transmission opportunity and communications between the second access point and one or more second stations during the transmission opportunity, the first information including one or more of a channel quality threshold for communications with the one or more first stations during the transmission opportunity, an absolute transmit power of the second access point or both an absolute transmit power of the first access point and an absolute transmit power of the second access point normalized to a unit of bandwidth associated with the transmission opportunity, a relative transmit power normalized to a unit of bandwidth of the second access point relative to a reference frame transmitted by the second access point or both a relative transmit power of normalized to a unit of bandwidth the first access point and a relative transmit power normalized to a unit of bandwidth of the second access point relative to a reference frame transmitted by a corresponding access point, or an identifier of the reference frame and means for communicating with one or more first stations during the transmission opportunity in accordance with the first information.

Another innovative aspect of the subject matter described in this disclosure can be implemented in a non-transitory computer-readable medium storing code for wireless communications. The code may include instructions executable by one or more processors to transmit, to a second access point, first information associated with coordinated spatial reuse of resources of a transmission opportunity that provides for communications between the first access point and one or more first stations during the transmission opportunity and communications between the second access point and one or more second stations during the transmission opportunity, the first information including one or more of a channel quality threshold for communications with the one or more first stations during the transmission opportunity, an absolute transmit power of the second access point or both an absolute transmit power of the first access point and an absolute transmit power of the second access point normalized to a unit of bandwidth associated with the transmission opportunity, a relative transmit power normalized to a unit of bandwidth of the second access point relative to a reference frame transmitted by the second access point or both a relative transmit power of normalized to a unit of bandwidth the first access point and a relative transmit power normalized to a unit of bandwidth of the second access point relative to a reference frame transmitted by a corresponding access point, or an identifier of the reference frame and communicate with one or more first stations during the transmission opportunity in accordance with the first information.

In some examples of the method, first access points, and non-transitory computer-readable medium described herein, the channel quality threshold includes one or more of a modulation and coding scheme (MCS), an error vector magnitude (EVM), or an interference threshold for communications with the one or more first stations during the transmission opportunity.

In some examples of the method, first access points, and non-transitory computer-readable medium described herein, the absolute transmit power may be a quantity associated with a bandwidth that may be a portion of a total bandwidth associated with the transmission opportunity.

In some examples of the method, first access points, and non-transitory computer-readable medium described herein, the relative transmit power indicates a power backoff from a power spectral density level at which a prior packet or physical layer protocol data unit may be transmitted by the first access point.

In some examples of the method, first access points, and non-transitory computer-readable medium described herein, the first information indicates that the reference frame may be associated with a previous ready-to-send (RTS) and clear-to-send (CTS) exchange between the first access point and the one or more first stations.

Another innovative aspect of the subject matter described in this disclosure can be implemented in a method for wireless communications by a first access point. The method may include transmitting, to a second access point, first information associated with coordination of resources of a transmission opportunity, the first information including one or more alignment parameters for concurrent transmissions of at least a first physical layer protocol data unit (PPDU) from the first access point and a second PPDU from the second access point during the transmission opportunity, and the first access point and the second access point having overlapping coverage areas and communicating with one or more stations during the transmission opportunity in accordance with the first information.

Another innovative aspect of the subject matter described in this disclosure can be implemented in a first access point for wireless communications. The first access point may include a processing system that includes processor circuitry and memory circuitry that stores code. The processing system may be configured to cause the first access point to transmit, to a second access point, first information associated with coordination of resources of a transmission opportunity, the first information including one or more alignment parameters for concurrent transmissions of at least a first physical layer protocol data unit (PPDU) from the first access point and a second PPDU from the second access point during the transmission opportunity, and the first access point and the second access point having overlapping coverage areas and communicate with one or more stations during the transmission opportunity in accordance with the first information.

Another innovative aspect of the subject matter described in this disclosure can be implemented in a first access point for wireless communications is described. The first access point may include means for transmitting, to a second access point, first information associated with coordination of resources of a transmission opportunity, the first information including one or more alignment parameters for concurrent transmissions of at least a first physical layer protocol data unit (PPDU) from the first access point and a second PPDU from the second access point during the transmission opportunity, and the first access point and the second access point having overlapping coverage areas and means for communicating with one or more stations during the transmission opportunity in accordance with the first information.

Another innovative aspect of the subject matter described in this disclosure can be implemented in a non-transitory computer-readable medium storing code for wireless communications. The code may include instructions executable by one or more processors to transmit, to a second access point, first information associated with coordination of resources of a transmission opportunity, the first information including one or more alignment parameters for concurrent transmissions of at least a first physical layer protocol data unit (PPDU) from the first access point and a second PPDU from the second access point during the transmission opportunity, and the first access point and the second access point having overlapping coverage areas and communicate with one or more stations during the transmission opportunity in accordance with the first information.

Some examples of the method, first access points, and non-transitory computer-readable medium described herein may further include operations, features, means, or instructions for receiving, from the second access point, second information that indicates one or more timing parameters for the concurrent transmissions of PPDUs, and where communications with the one or more stations may be in accordance with the first information and the second information.

In some examples of the method, first access points, and non-transitory computer-readable medium described herein, the first PPDU and the second PPDU each share a common preamble up to one or more of a legacy signal (L-SIG) field, an ultra-high reliability signal (UHR-SIG) field, or an ultra-high reliability long training field (UHR-LTF), the common preamble transmitted from each of the first access point and the second access point during the transmission opportunity, and where the first information further indicates a value of a LENGTH subfield of the L-SIG field.

In some examples of the method, first access points, and non-transitory computer-readable medium described herein, the first PPDU and the second PPDU each indicate a same basic service set (BSS) color in a universal signal (U-SIG) field.

In some examples of the method, first access points, and non-transitory computer-readable medium described herein, the universal signal (U-SIG) field of the first PPDU and the second PPDU includes one or more of an indication that the first PPDU and the second PPDU may be transmitted in accordance with coordinated spatial reuse (C-SR) procedures, and an indication of a basic service set (BSS) color of one or more of the first access point, the second access point, or a group BSS color associated with the first access point and the second access point.

In some examples of the method, first access points, and non-transitory computer-readable medium described herein, the first access point and the second access point use a same compression mode for communications during the transmission opportunity. In some examples of the method, first access points, and non-transitory computer-readable medium described herein, the first access point uses a first compression mode during the transmission opportunity that may be different than a second compression mode used by the second access point, and where a PPDU preamble of the first PPDU and the second PPDU includes separate compression mode subfields that indicate the first compression mode and the second compression mode.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example physical layer (PHY) protocol data unit (PPDU) usable for communications between a wireless AP and one or more wireless STAs.

FIG. 4 shows a pictorial diagram of another example wireless communication network.

FIGS. 5A and 5B show examples of signaling diagrams that support coordinated spatial reuse in Wi-Fi.

FIGS. 6A and 6B show examples of channel sounding techniques that support coordinated spatial reuse in Wi-Fi.

FIG. 7 shows an example of a signaling diagram that supports coordinated spatial reuse in Wi-Fi.

FIG. 8 shows a block diagram of an example wireless communication device that supports coordinated spatial reuse in Wi-Fi.

FIGS. 9 through 11 show flowcharts illustrating example processes performable by or at a first access point that supports coordinated spatial reuse in Wi-Fi.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, wireless communications devices may coordinate resources for a transmission opportunity (TXOP). Coordination of the resources may include a sharing access point (AP) and a shared AP exchanging messages associated with the coordination of the resources and STAs that are to be scheduled by one or more of the sharing and the shared AP for communications during the TXOP. Various types of coordinated access procedures may be implemented by the wireless communication devices such as to reduce interference between communications by the sharing and the shared APs and respective STAs. For example, a coordinated beamforming (COBF) transmission mode may leverage hardware capabilities of an AP to null signals directed to overlapping basic service set (OBSS) STAs scheduled by another AP during the TXOP. A coordinated special reuse (C-SR) transmission mode relies on isolation between respective APs and STAs to coordinate resources and transmit power control, rather than actively nulling signals. The COBF and the C-SR transmission modes may utilize various measurements reported by the STAs to coordinate resources in accordance with the utilized transmission modes. However, wireless communications device may leverage one type of measurement to implement one of the transmission modes to coordinate resources of a TXOP, but utilization of one or more different transmission modes, in accordance with various measurement considerations, coordination between APs, and alignment of communications, among other considerations, may be beneficial for resource coordination and throughput.

Various aspects relate generally to a signaling, measurement, and alignment of communications for implementing the coordinated communications among multiple APs, such as for the COBF transmission mode and the C-SR transmission mode. Some aspects more specifically relate to a sharing and shared AP exchange of communications that facilitate the coordinated communications using C-SR or COBF communications within a shared TXOP. In some implementations, a first AP may receive one or more reports of channel parameters from one or more first STAs, the channel parameters associated with a second AP. The first AP may transmit, to the second AP, a trigger message that includes a first information that provides an indication of coordinated resources and identifiers for one or more second STAs for coordinated communications during the shared TXOP. The first AP may proceed with communications with the one or more first STAs using the C-SR or COBF transmission mode in accordance with the first information.

Some further aspects more specifically relate to measurements associated with a cross-BSS channel during a measurement phase of AP coordination. In some aspects, the first AP may transmit first information to a second AP that indicates one or more parameters associated with channel conditions associated with coordinated communications during a shared TXOP. In some specific aspects, the first information may include one or more of a channel quality threshold for communications with one or more second STAs during the shared TXOP, an absolute transmit power of the second AP or both the first and second APs normalized to a unit of bandwidth associated with the shared TXOP, a relative transmit power (such as a backoff from a power spectral density level) of the second AP or both the first and second APs relative to a reference frame transmitted by the first AP, or an identifier of the reference frame. To facilitate coordinated communications as described herein, a wireless communications device (STA) may transmit, during a channel state information (CSI) reporting frame, measurement information that includes, for example, a CSI measurement and a received signal strength indicator (RSSI) measurement associated with a first transmission by the serving AP and a CSI measurement and an RSSI measurement associated with a second transmission by a second, non-serving AP. The APs may utilize at least a portion of this information to evaluate whether the APs are able to attenuate transmit signals for C-SR or COBF transmission mode facilitation and to determine whether the served STAs are subject to interference by other APs such as to facilitate C-SR or COBF transmission mode operations.

Some further aspects more specifically relate to alignment of concurrent communications during a shared TXOP in accordance with C-SR of COBF transmission mode operations. In some aspects, transmitted physical layer protocol data units (PPDUs) of each AP may share a common preamble up to a defined field, such as a legacy signature field (L-SIG), a universal signature field (U-SIG), an ultra-high reliability (UHR) signature field (UHR-SIG), or a UHR long training field (UHR-LTF). In some aspects, the first AP may transmit first information that provides one or more signaled parameters for concurrent transmissions of at least a first PPDU and a second PPDU from the first AP and the second AP during the shared TXOP. The signaled parameters may indicate, for example, a TXOP duration, common preamble information such as for a common L-SIG, UHR-SIG, or U-SIG preamble that is transmitted in the first and second PPDUs, BSS color, or C-SR or COBF indication information.

Particular aspects of the subject matter described in this disclosure can be implemented to realize one or more of the following potential advantages. In some implementations, by using the signaling framework for facilitating the COBF transmission mode or the C-SR transmission mode, the wireless communication devices may be able to utilize the transmission mode that supports communications in accordance with channel conditions between the wireless communications devices and capabilities of the wireless communications devices. Additionally, some transmission modes may provide greater communication performance and reliability, provided that operating conditions are suitable for those transmission modes, and particular aspects of the subject matter described in this disclosure facilitate selection and utilization of the transmission mode that suits a current operating condition based on channel quality thresholds, and absolute or relative transmit powers of APs. Moreover, in some implementations, the CSI reporting in conjunction with OBSS RSSI reporting may facilitate the selection and utilization of one of the transmission modes. Further, alignment parameters for concurrent communications may facilitate enhanced reception and processing of communications of PPDUs that are transmitted by multiple APs. In accordance with achieving such mode selection and utilization of a transmission mode, the described techniques can be further implemented to realize higher data rates, greater spectral efficiency, improved latency, and greater system capacity, among other benefits.

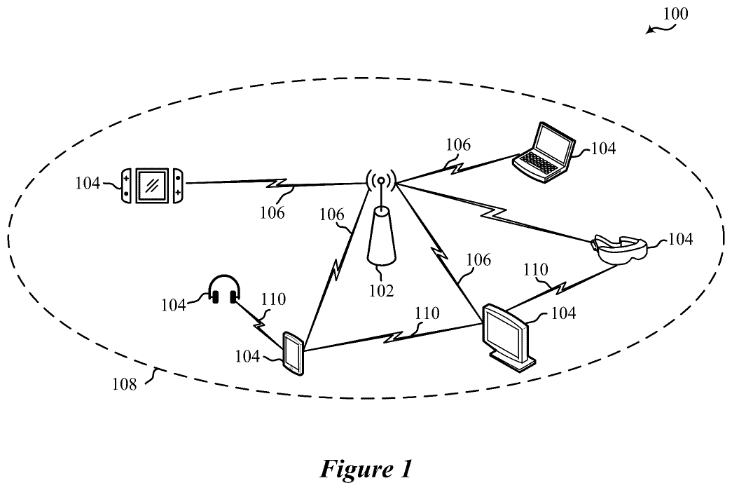

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR- or IEEE 802.11bn-compatible) devices for opportunistic access to spectrum that may be otherwise under-utilized.

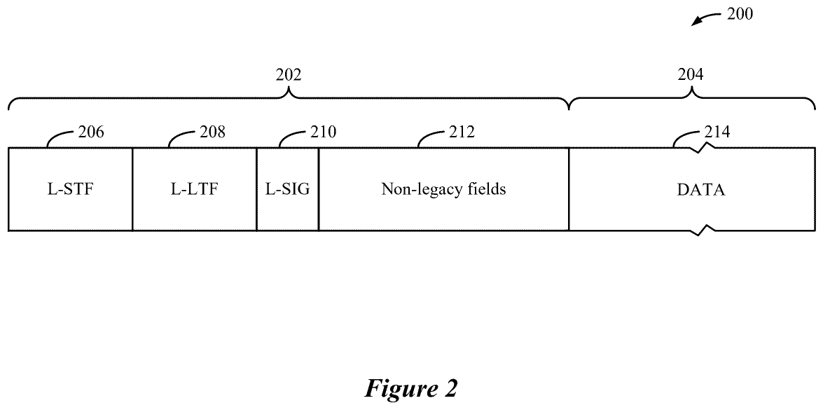

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

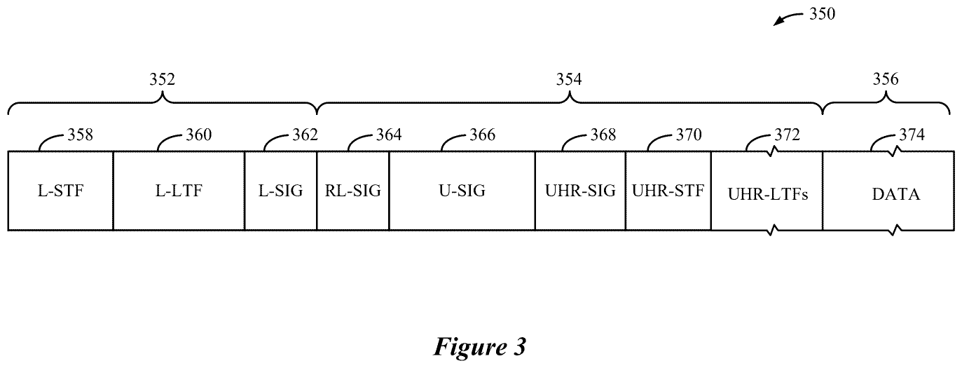

FIG. 3 shows an example physical layer (PHY) protocol data unit (PPDU) 350 usable for communications between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, and a payload 356 that includes a data field 374. The legacy portion 352 of the preamble includes an L-STF 358, an L-LTF 360, and an L-SIG 362. The non-legacy portion 354 of the preamble includes a repetition of L-SIG (RL-SIG) 364, a universal signal field 366 (referred to herein as “U-SIG 366”) and a UHR signal field 368 (referred to herein as “UHR-SIG 368”). The presence of RL-SIG 364 and U-SIG 366 may indicate to UHR or later version-compliant STAs 104 that the PPDU 350 is a UHR PPDU or a PPDU conforming to any later (post-UHR) version of a new wireless communication protocol conforming to a future IEEE 802.11 wireless communication protocol standard. One or both of U-SIG 366 and UHR-SIG 368 may be structured as, and carry version-dependent information for, other wireless communication protocol versions associated with amendments to the IEEE family of standards beyond UHR. For example, U-SIG 366 may be used by a receiving device (such as an AP 102 or a STA 104) to interpret bits in one or more of UHR-SIG 368 or the data field 374. U-SIG 366 may include one or more universal, version-independent fields and one or more version-dependent fields. Information in the universal fields may include, for example, a version identifier (starting from the IEEE 802.11be amendment and beyond) and channel occupancy and coexistence information (such as a punctured channel indication). The version-dependent fields may include format information fields used for interpreting other fields of U-SIG 366 and UHR-SIG 368 and additional information fields or single user (SU)-specific fields that may be useful to intended recipients. In some implementations, the version-dependent fields may include at least a PPDU format field to indicate a general PPDU format for the PPDU 350 (such as a trigger-based (TB), a single-user (SU), or a multi-user (MU) PPDU format). Like L-STF 358, L-LTF 360, and L-SIG 362, the information in U-SIG 366 and UHR-SIG 368 may be duplicated and transmitted in each of the component 20 MHz channels in instances involving the use of a bonded channel.

The non-legacy portion 354 further includes an additional short training field 370 (referred to herein as “UHR-STF 370,” although it may be structured as, and carry version-dependent information for, other wireless communication protocol versions beyond UHR) and one or more additional long training fields 372 (referred to herein as “UHR-LTFs 372,” although they may be structured as, and carry version-dependent information for, other wireless communication protocol versions beyond UHR). UHR-STF 370 may be used for timing and frequency tracking and AGC, and UHR-LTF 372 may be used for more refined channel estimation.

UHR-SIG 368 may be used by an AP 102 to identify and inform one or multiple STAs 104 that the AP 102 has scheduled uplink (UL) or downlink (DL) resources for them. UHR-SIG 368 may be decoded by each compatible STA 104 served by the AP 102. UHR-SIG 368 also may generally be used by the receiving device to interpret bits in the data field 374. For example, UHR-SIG 368 may include resource unit (RU) allocation information, spatial stream configuration information, and per-user (for example, STA-specific) signaling information. Each UHR-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

In some wireless communications systems, a STA 104 or an AP 102 may transmit the PPDU 350 over bandwidths larger than the 20 MHz, 40 MHz, 80 MHz, 160 MHz, and 320 MHz bandwidths supported by previous generations of IEEE-compliant wireless communication systems. For example, the PPDU 350 may support 480 MHz or 640 MHz bandwidth communications. By increasing the channel bandwidth of the PPDU 350 to 480 MHz or 640 MHz, more data may be transmitted because more or larger RUs are available based on the larger bandwidth, and accordingly, higher peak throughput or increased capacity may be achieved. Parameters for assembling and transmitting the 480 MHz or 640 MHz PPDUs may be defined to account for the larger bandwidths. For example, parameters or designs such as the tone plans, resource unit allocation indications, spatial reuse fields, UHR-STFs 370, UHR-LTFs 372, pilot signal locations, phase shifts, and spectral masks may be optimized or otherwise selected in accordance with the 480 MHz or 640 MHz bandwidths. In some examples, the spatial reuse fields may enable multiple BSSs to operate on the same 480 MHz or 640 MHz bandwidth channels.

In some examples, UHR-capable STAs 104 and APs 102 may support unequal modulation techniques (also referred to as unequal quadrature amplitude modulation (QAM)) with joint encoding across multiple streams for MIMO communications. For example, while different data streams may be transmitted using different spatial streams, or different resource units (RUs), or both, different spatial streams or RUs may be associated with different levels of quality (such as a different signal to noise ratios (SNRs)), and it may be advantageous to use different (unequal) MCSs for different spatial streams or RUs.

To support unequal modulation, an AP 102 may transmit signaling that indicates unequal MCSs across spatial streams or RUs to multiple STAs 104. For example, the AP 102 may transmit an MCS configuration message, which may be an example of a PHY preamble included in control signaling for PHY layer configuration, to indicate the unequal MCSs. In some examples, an MCS field of the MCS configuration message may include entries for unequal QAM schemes across multiple spatial streams, where the multiple spatial streams may be encoding with the same code rate.

In some wireless communication systems, wireless communication devices may support low density parity check (LDPC) coding for forward error correcting purposes to increase the likelihood of accurate data transmission. In some examples, UHR-capable STAs 104 and APs 102 may be capable of selecting among multiple LDPC codeword lengths, including 648 bits, 1296 bits and 1944 bits (defined in legacy IEEE 802.11 wireless communications protocol standards), as well as even longer (extended) codeword lengths, which may increase as operating bandwidths increase, higher modulation orders are introduced, or more spatial streams are available. Using longer LDPC codewords may achieve lower block error rates in some channels, such as channels associated with additive white Gaussian noise. Longer LDPC codewords also may enable more reliable communications in channels with lower SNRs. To facilitate the use of multiple LDPC codeword lengths, a STA 104 and an AP 102 may each include multiple LDPC encoders and multiple LDPC decoders. In some examples, such a STA 104 or AP 102 may connect, aggregate or otherwise utilize multiple encoders to implement a larger single encoder capable of encoding a longer codeword, or similarly, utilize multiple decoders to implement a larger single decoder capable of decoding a longer codeword, which may increase performance gains associated with larger block sizes without substantially increasing the hardware cost or complexity. In some examples, to generate an extended LDPC codeword, a STA 104 or an AP 102 may implement one or more lifting operations to extend a shorter codeword, with each lifting operation extending the previously lifted codeword. A “lifting” operation enables LDPC codes to be implemented using parallel encoding or decoding implementations while also reducing the complexity typically associated with large LDPC codewords. In some examples, a STA 104 or an AP 102 may use mixed codeword lengths for a given transmission. For example, the STA 104 or the AP 102 may encode input bits into one or more codewords having a first, longer codeword length (more than 1944 bits) and one or more codewords having a second, shorter codeword length (1944 bits or less). In such examples, the STA 104 or the AP 102 may perform shortening or puncturing on the codewords having the longer codeword length, or on the codewords having the shorter codeword length, or both.

To support increased range or rate-over-range, a STA 104 and an AP 102 may support extended long range (ELR) PPDU formats. The use of an ELR PPDU format can enable the achievement of a target data rate while maintaining an existing coverage range, reduce an uplink/downlink power imbalance (due to, for example, one or more regulations or hardware differences at the uplink and downlink devices), or extend a coverage range while maintaining a similar, or slightly lower, data rate as compared with other PPDU formats. In some examples, an ELR PPDU may be transmitted over a narrow bandwidth, which may have a lower noise floor and thus higher SNR, thereby extending the coverage range. The reliability of the transmission of an ELR PPDU also may be increased as a result of using various optimized coding rates, coded bit repetition schemes, or duplication schemes, which may provide for improved decodability and fewer retransmissions. In some examples, the U-SIG 366 of an ELR PPDU 350 may include a first indication (for example, a codepoint of a PHY version identifier subfield within a version-independent portion of the U-SIG 366 or a value of an ELR subfield within a version-dependent portion of the U-SIG 366) that the PPDU 350 is associated with an ELR format. The U-SIG 366 of an ELR PPDU 350 may include a second indication (for example, a STA identifier subfield within the version-dependent portion of the U-SIG 366) of an intended receiver of the PPDU. In some examples, an ELR PPDU 350 may include an ELR-signature (ELR-SIG) field that includes an uplink/downlink indicator subfield, a length subfield, a coding indicator subfield, and a modulation and coding scheme (MCS) subfield.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (for example, by generating a message integrity check (MIC) for one or more relevant fields.

Some APs and STAs (for example, the AP 102 and the STAs 104 described with reference to FIG. 1) may implement spatial reuse techniques. For example, APs 102 and STAs 104 configured for communications using the protocols defined in the IEEE 802.11ax or 802.11be standard amendments may be configured with a BSS color. APs 102 associated with different BSSs may be associated with different BSS colors. A BSS color is a numerical identifier of an AP 102's respective BSS (such as a 6 bit field carried by the SIG field). Each STA 104 may learn its own BSS color upon association with the respective AP 102. BSS color information is communicated at both the PHY and MAC sublayers. If an AP 102 or a STA 104 detects, obtains, selects, or identifies, a wireless packet from another wireless communication device while contending for access, the AP 102 or the STA 104 may apply different contention parameters in accordance with whether the wireless packet is transmitted by, or transmitted to, another wireless communication device (such another AP 102 or STA 104) within its BSS or from a wireless communication device from an overlapping BSS (OBSS), as determined, identified, ascertained, or calculated by a BSS color indication in a preamble of the wireless packet. For example, if the BSS color associated with the wireless packet is the same as the BSS color of the AP 102 or STA 104, the AP 102 or STA 104 may use a first RSSI detection threshold when performing a CCA on the wireless channel. However, if the BSS color associated with the wireless packet is different than the BSS color of the AP 102 or STA 104, the AP 102 or STA 104 may use a second RSSI detection threshold in lieu of using the first RSSI detection threshold when performing the CCA on the wireless channel, the second RSSI detection threshold being greater than the first RSSI detection threshold. In this way, the criteria for winning contention are relaxed when interfering transmissions are associated with an OBSS.

Some APs and STAs (for example, the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communications with its associated STAs.

In some examples of such TDMA techniques, each portion of a plurality of portions of the TXOP includes a set of time resources that do not overlap with any time resources of any other portion of the plurality of portions of the TXOP. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some examples of OFDMA techniques, each portion of the plurality of portions of the TXOP includes a set of frequency resources that do not overlap with any frequency resources of any other portion of the plurality of portions. In such examples, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or enhanced distributed channel access (EDCA) techniques. Additionally, by enabling a group of APs 102 associated with different BSSs to participate in a coordinated AP transmission session, during which the group of APs may share at least a portion of a single TXOP obtained by any one of the participating APs, such techniques may increase throughput across the BSSs associated with the participating APs and also may achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may be allocated resources during the TXOP as described above.

APs and STAs (for example, the AP 102 and the STAs 104 described with reference to FIG. 1) that include multiple antennas may support various diversity schemes. For example, spatial diversity may be used by one or both of a transmitting device (such as an AP 102 or a STA 104) or a receiving device (such as an AP 102 or a STA 104) to increase the robustness of a transmission. For example, to implement a transmit diversity scheme, a transmitting device may transmit the same data redundantly over two or more antennas.

APs 102 and STAs 104 that include multiple antennas also may support space-time block coding (STBC). With STBC, a transmitting device also transmits multiple copies of a data stream across multiple antennas to exploit the various received versions of the data to increase the likelihood of decoding the correct data. More specifically, the data stream to be transmitted is encoded in blocks, which are distributed among the spaced antennas and across time. Generally, STBC can be used when the number N_{TX} of transmit antennas exceeds the number N_{SS} of spatial streams. The N_{SS} spatial streams may be mapped to a number N_{STS} of space-time streams, which are mapped to N_{TX} transmit chains.

APs 102 and STAs 104 that include multiple antennas also may support spatial multiplexing, which may be used to increase the spectral efficiency and the resultant throughput of a transmission. To implement spatial multiplexing, the transmitting device divides the data stream into a number N_{SS} of separate, independent spatial streams. The spatial streams are separately encoded and transmitted in parallel via the multiple N_{TX} transmit antennas.

APs 102 and STAs 104 that include multiple antennas also may support beamforming. Beamforming generally refers to the steering of the energy of a transmission in the direction of a target receiver. Beamforming may be used both in a single-user (SU) context, for example, to improve a signal-to-noise ratio (SNR), as well as in a multi-user (MU) context, for example, to enable MU-MIMO transmissions (also referred to as spatial division multiple access (SDMA)). In the MU-MIMO context, beamforming may additionally, or alternatively, involve the nulling out of energy in the directions of other receiving devices. To perform SU beamforming or MU-MIMO, a transmitting device, referred to as the beamformer, transmits a signal from each of multiple antennas. The beamformer configures the amplitudes and phase shifts between the signals transmitted from the different antennas such that the signals add constructively along particular directions towards the intended receiver (referred to as the beamformee) or add destructively in other directions towards other devices to mitigate interference in a MU-MIMO context. The manner in which the beamformer configures the amplitudes and phase shifts depends on channel state information (CSI) associated with the wireless channels over which the beamformer intends to communicate with the beamformee.

To obtain the CSI necessary for beamforming, the beamformer may perform a channel sounding procedure with the beamformee. For example, the beamformer may transmit one or more sounding signals (for example, in the form of a null data packet (NDP)) to the beamformee. An NDP is a PPDU without any data field. The beamformee may perform measurements for each of the N_{TX}×N_{RX} sub-channels corresponding to all of the transmit antenna and receive antenna pairs associated with the sounding signal. The beamformee generates a feedback matrix associated with the channel measurements and, typically, compresses the feedback matrix before transmitting the feedback to the beamformer. The beamformer may generate a precoding (or “steering”) matrix for the beamformee associated with the feedback and use the steering matrix to precode the data streams to configure the amplitudes and phase shifts for subsequent transmissions to the beamformee. The beamformer may use the steering matrix to determine (for example, identify, detect, ascertain, calculate, or compute) how to transmit a signal on each of its antennas to perform beamforming. For example, the steering matrix may be indicative of a phase shift, or a power level, to use to transmit a respective signal on each of the beamformer's antennas.

When performing beamforming, the transmitting beamforming array gain is logarithmically proportional to the ratio of N_{TX} to N_{SS}. As such, it is generally desirable, within other constraints, to increase the number N_{TX} of transmit antennas when performing beamforming to increase the gain. It is also possible to more accurately direct transmissions or nulls by increasing the number of transmit antennas. This is especially advantageous in MU transmission contexts in which it is particularly important to reduce inter-user interference.

To increase an AP 102's spatial multiplexing capability, an AP 102 may need to support an increased number of spatial streams (such as up to 16 spatial streams). However, supporting additional spatial streams may result in increased CSI feedback overhead. Implicit CSI acquisition techniques may avoid CSI feedback overhead by taking advantage of the assumption that the UL and DL channels have reciprocal impulse responses (that is, that there is channel reciprocity). For example, the CSI feedback overhead may be reduced using an implicit channel sounding procedure such as an implicit beamforming report (BFR) technique (such as where STAs 104 transmit NDP sounding packets in the UL while the AP 102 measures the channel) because no BFRs are sent. Once the AP 102 receives the NDPs, it may implicitly assess the channels for each of the STAs 104 and use the channel assessments to configure steering matrices. In order to mitigate hardware mismatches that could break the channel reciprocity on the UL and DL (such as the baseband-to-RF and RF-to-baseband chains not being reciprocal), the AP 102 may implement a calibration method to compensate for the mismatch between the UL and the DL channels. For example, the AP 102 may select a reference antenna, transmit a pilot signal from each of its antennas, and estimate baseband-to-RF gain for each of the non-reference antennas relative to the reference antenna.

In some examples, multiple APs 102 may simultaneously transmit signaling or communications to a single STA 104 utilizing a distributed MU-MIMO scheme. Examples of such a distributed MU-MIMO transmission include coordinated beamforming (COBF) and joint transmission (JT). With COBF, signals (such as data streams) for a given STA 104 may be transmitted by only a single AP 102. However, the coverage areas of neighboring APs may overlap, and signals transmitted by a given AP 102 may reach the STAs in OBSSs associated with neighboring APs as OBSS signals. COBF allows multiple neighboring APs to transmit simultaneously while minimizing or avoiding interference, which may result in more opportunities for spatial reuse. More specifically, using COBF techniques, an AP 102 may beamform signals to in-BSS STAs 104 while forming nulls in the directions of STAs in OBSSs such that any signals received at an OBSS STA are of sufficiently low power to limit the interference at the STA. To accomplish this, an inter-BSS coordination set may be defined between the neighboring APs, which contains identifiers of all APs and STAs participating in COBF transmissions.

With JT, signals for a given STA 104 may be transmitted by multiple coordinated APs 102. For the multiple APs 102 to concurrently transmit data to a STA 104, the multiple APs 102 may all need a copy of the data to be transmitted to the STA 104. Accordingly, the APs 102 may need to exchange the data among each other for transmission to a STA 104. With JT, the combination of antennas of the multiple APs 102 transmitting to one or more STAs 104 may be considered as one large antenna array (which may be represented as a virtual antenna array) used for beamforming and transmitting signals. In combination with MU-MIMO techniques, the multiple antennas of the multiple APs 102 may be able to transmit data via multiple spatial streams. Accordingly, each STA 104 may receive data via one or more of the multiple spatial streams.

In some implementations, the AP 102 and STAs 104 can support various multi-user communications; that is, concurrent transmissions from one device to each of multiple devices (for example, multiple simultaneous downlink communications from an AP 102 to corresponding STAs 104), or concurrent transmissions from multiple devices to a single device (for example, multiple simultaneous uplink transmissions from corresponding STAs 104 to an AP 102). As an example, in addition to MU-MIMO, the AP 102 and STAs 104 may support OFDMA. OFDMA is in some aspects a multi-user version of OFDM.

In OFDMA schemes, the available frequency spectrum of the wireless channel may be divided into multiple resource units (RUs) each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHz, 26-tone RUs) may be allocated (because some tones are reserved for other purposes). Similarly, in a 160 MHz channel, up to 74 RUs may be allocated. Other tone RUs also may be allocated, such as 52 tone, 106 tone, 242 tone, 484 tone and 996 tone RUs. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (for example, APs 102 and STAs 104) to enhance various aspects associated with wireless communication. For example, an AI/ML model may be trained to identify patterns or relationships in data observed in a wireless communication network 100. An AI/ML model may support operational decisions implemented by one or more wireless communication devices relating to aspects described herein that are associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

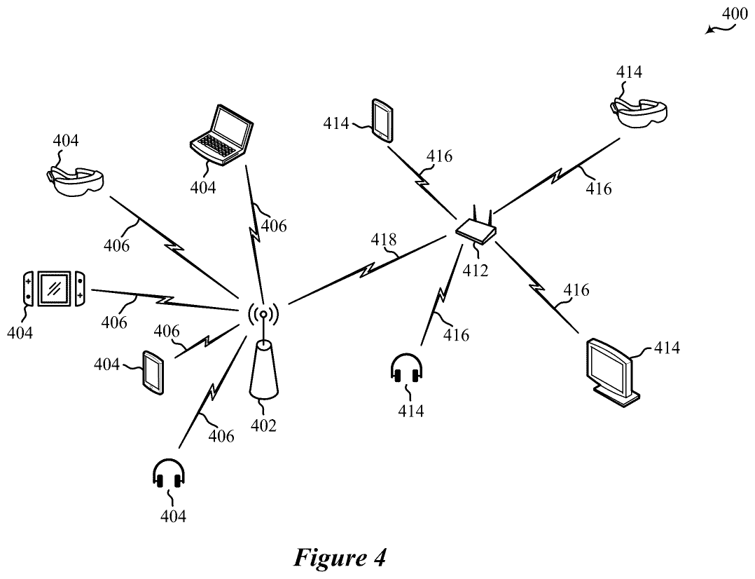

FIG. 4 shows a pictorial diagram of another example wireless communication network 400. According to some aspects, the wireless communication network 400 can be an example of a network in accordance with one or more of the IEEE 802.11 family of wireless communication protocol standards. The wireless communication network 400 may include multiple wireless communication devices, which in some implementations may include a first AP 402, a second AP 412, a first set of STAs 404 that communicate with the first AP 402 via communication links 406, and a second set of STAs 414 that communicate with the second AP 412 via communication links 416. The communication links 406 and the communication links 416 may be examples of communication links 106, the first AP 402 and second AP 412 may be examples of APs 102, and STAs of the first set of STAs 404 and the second set of STAs 414 may be examples of STAs 104 discussed with reference to FIGS. 1-3. In some aspects, the first AP 402 and the second AP 412 may communicate via communication link 418, which may be an example of a Wi-Fi link or communication link 106 as discussed with reference to FIGS. 1-3. The example wireless communication network 400 illustrates example operations and signaling for coordinated communications among the first AP 402 and the second AP 412 in a shared TXOP.

As described herein, the wireless communication devices, such as first AP 402, second AP 412, and STAs of the first set of STAs 404 or the second set of STAs 414, may implement a coordinated spatial reuse in Wi-Fi for selection and utilization of a transmission mode from a COBF or C-SR transmission mode. The transmission modes may be used to determine when to share resources among APs and when not to share such resources, and how to share resources among APs, with spatial nulling (in the COBF mode) or only with transmit power control but no spatial nulling (in the C-SR mode). In some aspects, to determine whether to share resources in accordance with the C-SR mode, clients (such as STAs of the first set of STAs 404 or the second set of STAs 414) may provide information related to interference from neighbor APs. For example, if a STA of the first set of STAs 404 is relatively unimpacted from interference from communications of the second AP 412 this may be indicated in a report that is provided to the first AP 402. The first AP 402, which may be an example of a sharing AP that is a holder of a shared TXOP, may use information from one or more reports (e.g., CSI or channel quality indicator (CQI) information) to select the C-SR or COBF transmission mode for coordinated communications with the second AP 412, which may be an example of a shared AP. In some aspects, the first AP 402 may be an example of a sharing AP or initiating AP that is a TXOP holder, and the second AP 412 may be an example of a shared AP or responding AP that gets to share the TXOP. In some situations, the roles of the APs may swap if the TXOP holder changes. For example, in one TXOP when the first AP 402 is the TXOP holder (sharing AP), the APs may perform sounding and C-SR transmission where the second AP 412 is the shared AP. In another TXOP when the second AP 412 becomes the TXOP holder (sharing AP), the APs may not need to repeat sounding or the measurement phase, but directly have the C-SR transmission where the first AP 402 is the shared AP. The AP roles may swap in different TXOPs, and the roles also may swap in the measurement phase and the transmission phase. While various examples discussed herein may reference the first AP 402 as having the role of the sharing AP and the second AP as having the role of the shared AP, it is to be understood that such roles may swap, and various techniques discussed herein may be used in such situations.

In some aspects, coordinated communications of the first AP 402 and the second AP 412 may be downlink communications, and may be implemented in UHR communications. For example, both ongoing and reuse transmissions of each of the first AP 402 and the second AP 412 may be in the downlink direction. In other aspects, coordinated communications may be in the uplink direction, or may be mixed uplink and downlink communications. In some aspects, the C-SR transmission mode may be implemented, which may be asymmetric C-SR in which only the second AP 412 may lower a transmit power to mitigate OBSS interference. In some aspects, the first AP 402 and the second AP 412 may negotiate how many dB of power reduction is to be applied at the second AP 412 (with 0 dB as one of the options). In other aspects, the C-SR transmission mode may be symmetric, where each of the first AP 402 and the second AP 412 lower their transmission power. In some aspects, the C-SR transmission mode may use non-OFDMA (which may be full bandwidth with or without punctured channels) for the shared TXOP, and the two BSSs may use a same PPDU bandwidth. In other aspects, the C-SR transmission mode may allow both non-OFDMA (full bandwidth with or without punctured channels) and partial bandwidth C-SR. In partial bandwidth C-SR, the second AP 412 may only transmit in partial bandwidth (such as 160 MHz) of the first AP 402 (e.g., 320 MHz), the two APs may operate in partially overlapping channels (such as 320 MHz-1 and 320 MHz-2 channels with C-SR in the overlapping 160 MHz). In some aspects, the C-SR transmission mode may limit C-SR to a PPDU bandwidth of 80 MHz and above. In some examples, in partial bandwidth C-SR, a RU or multiple RU (MRU) size may be limited to RU996 or RU484+242 (with a 20 MHz puncturing in 80 MHz) and above.

In some aspects, the C-SR transmission mode may be used for SU transmissions, and may be applicable to both full or partial bandwidth communications. Accordingly, the first AP 402 may transmit to one STA of the first set of STAs 404 and the second AP 412 may transmit to one STA of the second set of STAs 414. In other aspects, the C-SR transmission mode may be used for non-MU-MIMO transmissions. In the case of partial bandwidth C-SR, a non-MU-MIMO transmission from each AP (that is, each AP transmitting to one STA) in the entire C-SR bandwidth, and other STAs may be served in the remaining PPDU bandwidth (where MU-MIMO may or may not be used). In further aspects, the C-SR transmission mode may be used for SU transmission and OFDMA transmission without MU-MIMO. In OFDMA, there could be multiple RUs or MRUs in the C-SR bandwidth to serve different sets of STAs, with no MU-MIMO transmissions from each AP in each of such RUs or MRUs. In still further aspects, the C-SR transmission mode may be applicable to SU transmissions, OFDMA transmissions, and MU-MIMO transmissions. In such aspects, in each RU or MRU that spans the entire or partial C-SR bandwidth, an MU-MIMO transmission from each AP may be used.

In some aspects, the C-SR transmission mode may be initiated based on collected channel parameters that indicate C-SR may be suitable for communications. In some aspects, a measurement phase may collect CSI or CQI for the multi-AP scheme. In some examples, measurements may be based on a pathloss model, such as a model of a point-to-point channel between an AP and a non-AP STA, and measurements may include RSSI or SNR, for example, or may be based on a signal to interference and noise ratio (SINR) model based on data transmissions. Measurement feedback may include, for example, long term CQI of in-BSS and OBSS downlink channels, such as BSS color and RSSI information, of a STAs own AP and OBSS APs. In some aspects, the first AP 402 may keep track of the RSSI or SNR levels from the second AP 412 (and optionally one or more other APs) to each STA of the first set of STAs 404. For example, a moving average of the RSSI or SNR level may be tracked, and the first AP 402 may identify hidden nodes (such as with RSSI or SNR below a packet detection (PD) level) if a STA has not provided RSSI or SNR feedback for an OBSS AP for a period of time. In some aspects, additionally, or alternatively, the measurement feedback may include short term CSI or CQI feedback from sounding procedures.

In order to initiate the C-SR transmission mode, or the COBF transmission mode, a coordination phase may be initiated, which may also be referred to as a setup phase or announcement phase. This is a phase for AP-to-AP coordination for C-SR or COBF, including one or more of BSS selection, STA selection, or transmit power coordination. The coordination phase may be used to decide on one or more of a shared AP (such as second AP 412 that gets to share a TXOP), non-AP STAs served by each of the first AP 402 and the second AP 412, which may happen before sounding or channel measurements, and therefore not directly preceding the transmission phase. The coordination phase to decide on a shared AP may also be after the measurement phase, based on the CSI or CQI feedback from sounding procedures. In some aspects, the coordination phase may include a trigger frame transmitted by the first AP 402, or may include a 3-way handshake between the first AP 402 and the second AP 412.

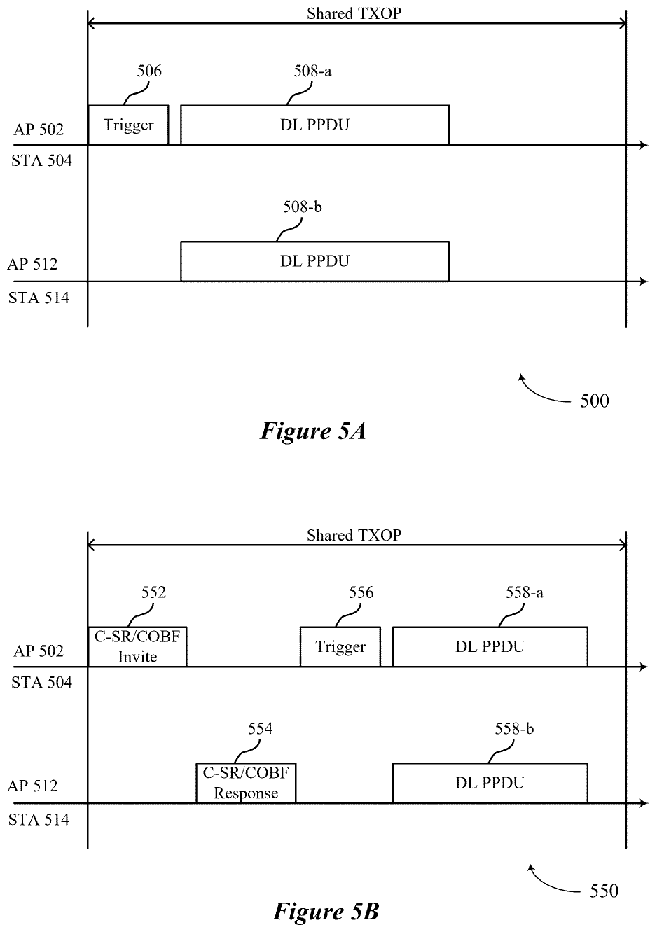

Following the coordination phase, a transmission phase may have concurrent C-SR transmissions or COBF transmissions from each of the first AP 402 and the second AP 412. In some aspects, coordination may be done based on long term CQI or before a short term sounding and CSI/CQI feedback, and a single trigger frame from the first AP 402 (the sharing AP) to the second AP 412 (the shared AP) may announce the TOXP sharing with the second AP 412, signal information for the second AP 412 to control transmit power, and allow the second AP 412 to synchronize. The trigger frame may further include signaling information about transmit power control of the first AP 402. In other aspects, coordination may be performed based on a 3-way handshake, in which multiple frames are exchange for coordination before the C-SR or COBF transmission, to confirm the coordination mode, negotiate transmit power(s), and/or exchange contents to form a common preamble. Examples of such coordination and transmission techniques are discussed in more detail with reference to FIGS. 5A and 5B.

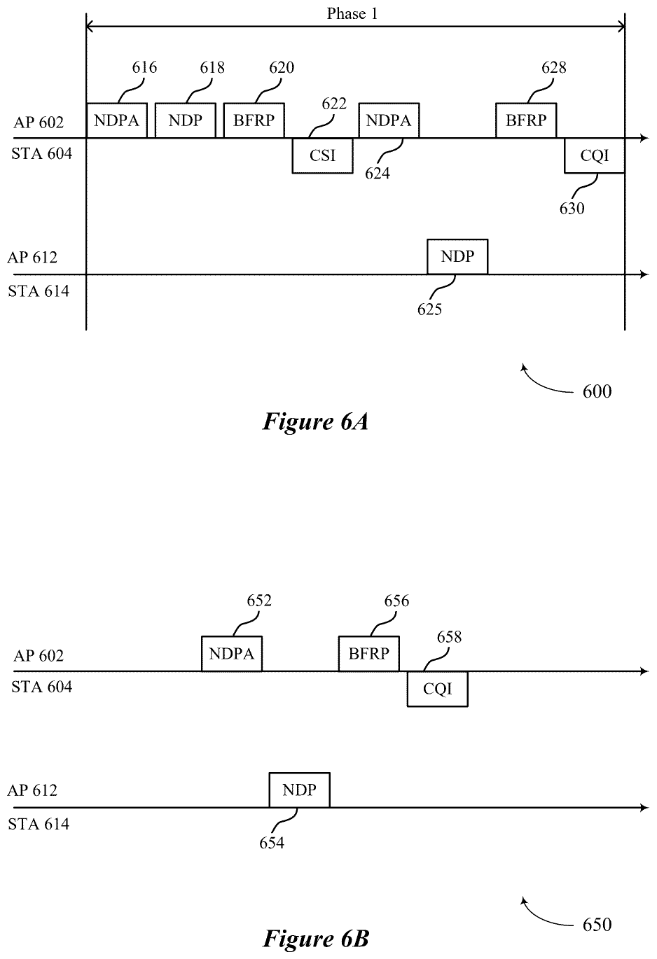

As discussed herein, in some aspects a C-SR transmission mode may be implemented. Such a transmission mode may be selected based on measurement feedback received at the first AP 402 and/or measurement feedback received at the second AP 412. For example, STAs of the first set of STAs 404 may report RSSI or SNR based on beacons or other OBSS AP frames, and the first AP 402 may decide which STAs are good candidates for C-SR with a certain OBSS AP, and which are good for COBF with a certain OBSS AP, based on this background process. Further, in some examples, the first AP 402 may perform coordinated sounding, and then determine whether coordinated communications will implement the COBF transmission mode or the C-SR transmission mode, such as based on isolation between the first AP 402 and the second AP 412 that is measured during sounding. The isolation may be defined according to the CQI difference between the in-BSS channel link from an own AP to a STA and the cross-BSS channel link from an OBSS AP to the same STA. With small isolation, spatial nulling (the COBF mode) may be preferred, while on the other hand, with large isolation, spatial nulling (the COBF mode) may not be needed and the C-SR mode may be a more efficient reuse scheme. In examples where the C-SR transmission mode is selected, then subsequent sounding procedures may be simplified to CQI only sounding for cross-BSS links, as discussed in more detail with reference to FIGS. 6A and 6B.

In some examples, given the CSI feedback, the first AP 402 may perform beamforming after sounding, and the second AP 412 may perform a larger power backoff when beamforming, to account for the impact of un-intentional beamforming. In examples where symmetric C-SR is used, the first AP 402 may also perform a transmit power backoff to account for potential un-intentional beamforming to the second set of STAs 414 in the OBSS. In examples where asymmetric C-SR is used, the transmit power backoff of each AP may be different.

In some aspects, the C-SR transmission mode and the COBF transmission mode may have an aligned protocol for PPDU transmissions. For example, the PPDUs from each of the first AP 402 and the second AP 412 may be synchronized and common up to a certain field in the preamble of the PPDU, and a 3-way handshake before C-SR transmissions and to COBF transmissions may be performed to exchange signaling information to form some common preamble fields. Additionally, start and end times of PPDUs may be the same. In other aspects, different protocols may be used for the C-SR transmission mode and the COBF transmission mode. In such aspects, PPDU transmissions in the C-SR mode may not be synchronized, and no common portions of PPDU preambles may be used. Further, because less synchronization is present, less coordination may be used, and a single trigger frame prior to concurrent PPDU transmissions in the C-SR mode may be sufficient.

In some aspects, as discussed herein, selection of the C-SR transmission mode or the COBF transmission mode may be made in accordance with channel measurements. In some examples, pathloss measurements may have been performed as part of an earlier protocol or observing earlier frames, which may allow for asymmetric C-SR and symmetric C-SR. In some examples, the pathloss measurement can happen based on the first set of STAs 404 observing recent beacon frames and reporting RSSIs or SNRs, although, in some examples, measurements may be based on frames other than beacon frames. In some examples, the pathloss measurement can happen in a previous sounding procedure, such as a full CSI sounding procedure that considers both COBF and C-SR as multi-AP transmission scheme options in the beginning (such as illustrated in FIG. 6A), and the decision of doing C-SR instead of COBF may be made after the sounding based on the CSI feedback. Further, in-between full CSI sounding (such as with spacing in the order of hundreds of milliseconds), cross-BSS channel(s) may be periodically sounded to update OBSS CQI (such as illustrated in FIG. 6B). In some examples, if the C-SR transmission mode has been made, only cross-BSS channel(s) may be sounded for a simple CQI feedback. The simple CQI feedback may be based on with a sounding with a single spatial stream. After the sounding, a COBF aligned option may use a 3-way handshake to exchange signaling information to form the common L-SIG, RL-SIG and U-SIG fields and have common preamble till U-SIG.

In some aspects, pathloss measurements may be obtained as part of a RTS-CTS exchange before a coordinated transmission (such as in the C-SR transmission mode). In some examples, such measurements may be used for asymmetric C-SR. In some aspects, a burst of C-SR transmissions may be performed, where multiple transmissions happen after one RTS-CTS.

FIGS. 5A and 5B show examples of signaling diagrams 500 and 550 that support coordinated spatial reuse in Wi-Fi. The signaling diagrams 500 and 550 include a first AP 502, a second AP 512, a first STA 504 that communicates with the first AP 502, and a second STA 514 that communicates with the second AP 512. The first AP 502, second AP 512, first STA 504, and second STA 514 may be examples of the APs and STAs as described herein with respect to FIGS. 1-4. The signaling diagrams 500 and 550 illustrate example operations and signaling for a coordination phase of the C-SR transmission mode or COBF transmission mode.

As described herein, the wireless communication devices may implement a framework for selection and utilization of a transmission mode from a COBF transmission mode or a C-SR transmission mode. The transmission modes may be used to determine when and how to share resources with other APs and when not to share such resources. In a first example of FIG. 5A, signaling diagram 500 indicates a single trigger frame 506 that may be transmitted prior to concurrent transmissions of a first downlink PPDU 508-a and a second downlink PPDU 508-b. In some examples, the single trigger frame 506 may be used when the C-SR transmission mode is selected, and may include first information related to coordinated transmissions such as an amount of transmit power backoff to be applied by the second AP 512, a duration of the shared TXOP, or both.

In a second example of FIG. 5B, signaling diagram 550 provides a 3-way handshake for the coordination mode, followed by concurrent transmission of a first downlink PPDU 558-a and a second downlink PPDU 558-b by the first AP 502 and the second AP 512, respectively. The 3-way handshake may include a C-SR/COBF invite frame 552 that is transmitted by the first AP 502 and received by the second AP 512. A C-SR/COBF response frame 554 may be transmitted by the second AP 512 and received by the first AP 502, which may be followed by a C-SR/COBF trigger frame 556 transmitted from the first AP 502 to the second AP 512. When using the 3-way handshake, the first AP 502 may decide if it shares the TXOP for a C-SR or COBF downlink transmission. Based on the selected STAs in the sharing BSS (such as the first STA 504), it can choose the second AP 512 as the shared AP and send a C-SR or COBF invite in the C-SR/COBF invite frame 552. The second AP 512 may accept the C-SR or COBF invite by sending the C-SR/COBF response frame 554 within a SIFS gap. In some aspects, the second AP 512 may simply ignore the C-SR/COBF invite frame 552, if not intending to participate in a coordinated transmission within the TXOP. In some examples, the C-SR/COBF response frame 554 may provide CQI info to the first AP 502, to allow the first AP 502 to determine how to control the transmit power or power backoff at the second AP 512. In the C-SR transmission mode, the first AP 502 may determine the transmit power or power backoff of the second AP 512, and send out the C-SR/COBF trigger frame 556 to solicit the C-SR transmission and signal the second AP 512 information to determine a transmit power and other parameters.

In the transmission phase, in the example of FIG. 5A, the first downlink PPDU 508-a and the second downlink PPDU 508-b may be transmitted based on a coordination phase that may be done based on long term CQI, or after a short term sounding and CSI/CQI feedback. In such examples, the coordination uses one C-SR/COBF trigger frame 506 from the first AP 502 to the second AP 512 to announce the TOXP sharing with the second AP 512, signal information for the second AP 512 to control a transmit power or power backoff, and allow the second AP 512 to synchronize in time and frequency with the first AP 502.

In the transmission phase, in the example of FIG. 5B, the first downlink PPDU 558-a and the second downlink PPDU 558-b may be transmitted based on a coordination phase that may be done based on the 3-way handshake. In such examples, there are at least three frames exchanged for coordination before the coordinated transmissions, to confirm the C-SR transmission mode or COBF transmission mode, negotiate transmit power(s) or power backoff(s), and/or exchange contents to form a common preamble up to a certain field. In some examples, information of the second AP 512 transmit power requirement may be sent in the C-SR/COBF invite frame 552 or the C-SR/COBF trigger frame 556.

In some aspects, the first downlink PPDU 508-a and the second downlink PPDU 508-b, or the first downlink PPDU 558-a and the second downlink PPDU 558-b, may be aligned in accordance with the selected transmission mode. In some examples, synchronization of the PPDUs in the C-SR mode is not performed, and different APs may transmit associated PPDUs within the shared TXOP based on a TXOP duration that may be announced in a preceding frame (such as the invite or trigger frames). In other examples, only coarse time and frequency synchronization is provided, such as through an indication of a TXOP duration or start and end times for PPDUs from both APs (such as provided in the C-SR/COBF invite or C-SR/COBF trigger frames). In further examples, time and frequency synchronization and symbol alignment may be provided for the concurrently transmitted PPDUs from a start of the PPDU until a certain field within each PPDU. For example, each transmitted PPDU of each AP may share a common preamble up to the L-SIG field, up to the U-SIG field (which may allow for receivers to decode U-SIG and understand the version independent information such as PHY version identifier, UL/DL, bandwidth, TXOP duration, BSS color), up to the UHR-SIG field, or up to the UHR-LTF field (to provide joint LTF, which may allow possible estimate of OBSS interfering channel and interference mitigation if spatial dimension allows).

In examples where PPDUs share a common preamble until the L-SIG field, the two APs may need to indicate a same value in the Length field in L-SIG. In some examples, the APs only need to exchange the length information, which may be decided by the sharing AP (such as the first AP 502). In examples where the PPDUs share a common preamble till U-SIG, both APs may set the version independent BSS color subfield to a same BSS color (such as the sharing AP's BSS color, the shared AP's BSS color, or a group BSS color to identify the group of sharing AP and shared AP) in the U-SIG. Additionally, the APs may also add additional signaling in U-SIG that provides a COBF or C-SR indication, the sharing AP BSS color (if not conveyed in the version independent BSS color subfield), and the shared AP BSS color (if not conveyed in the version independent BSS color subfield). In such examples, the two APs may exchange the Length in L-SIG and U-SIG signaling information such as the punctured channel information, and may use the same UHR-SIG MCS and same number of UHR-SIG symbols for the two concurrently transmitted PPDUs. In some examples, the APs may negotiate the UHR-SIG MCS and number of UHR-SIG symbols, and other signaling info may be solely decided by the sharing AP. The shared common preamble until the U-SIG field may be applicable to SU transmissions, OFDMA transmissions or non-OFDMA MU-MIMO transmissions in each BSS. Since the PPDU Type And Compression Mode subfield is common to both BSSs, each AP may use the same compression mode (such as SU, OFDMA or non-OFDMA MU-MIMO). Alternatively, the PPDU Type And Compression Mode subfield may be used for the sharing AP, and another subfield in U-SIG or the UHR-SIG common field may be added to indicate the shared AP's PPDU Type And Compression Mode subfield, so that the two BSSs may use different compression modes. In examples where a common preamble until the UHR-SIG field (without joint LTF) or UHR-LTF (with joint LTF) is used, such examples may be applicable to SU transmissions, OFDMA transmissions, or non-OFDMA MU-MIMO transmissions in each BSS. In such examples, the two APs may exchange the Length in L-SIG and U-SIG and UHR-SIG signaling information. Further, the BSS color field may be for the sharing AP, and an additional field may be added in U-SIG that provides a C-SR or COBF indication and the shared AP's BSS color.

In some aspects, where a common preamble until the UHR-SIG field (without joint LTF) or UHR-LTF (with joint LTF) is used, when full bandwidth C-SR is implemented (and for COBF), the PPDU Type And Compression Mode may be set as non-OFDMA MU-MIMO transmission, and differentiation of the BSS to which each user field is targeted may be provided using one or multiple options. For example, the Number of non-OFDMA users subfield in UHR-SIG may indicate the number of users in the sharing BSS and that in the shared BSS, as well as user fields in a certain order (such as user field(s) in the sharing BSS before the user field(s) in the shared BSS).

Alternatively, a one-bit BSS flag in the user field may be provided to indicate the associated AP. For example, in the MU-MIMO user field format, it may use the reserved bit for the 1-bit BSS flag, or repurpose the coding bit (to differentiate BCC and LDPC) for the 1-bit BSS flag, since LDPC may be always used for the RU or MRU size in C-SR and COBF. In the non-MU-MIMO user field format, in the case of spatial domain (SD) equal modulation (EQM), the coding bit (to differentiate BCC and LDPC) may be repurposed for the 1-bit BSS flag. In the case of SD unequal modulation (UEQM), it may repurpose the MSB of the 3-bit N_{SS} subfield for the 1-bit BSS flag, since only 2-4ss are used.

In some aspects, where a common preamble until the UHR-SIG field (without joint LTF) or UHR-LTF (with joint LTF) is used, when partial bandwidth C-SR or COBF is implemented, the PPDU Type And Compression Mode may be set as a downlink OFDMA transmission. In some examples, ways to differentiate the transmitting AP (or BSS) may include, an indication in the RU allocation subfield encoding for the (M)RUs with MU-MIMO in the case of CSR, the number of users (1-8 users) may be revised to indicate the number of user fields in the sharing BSS and that in the shared BSS and the ordering of the user fields (such as [N_user_sharing_BSS, N_user_shared_BSS, sharing BSS first] may take the values of [1, 0] or [2, 0](no C-SR), [1, 1], [1, 2], [2, 1], [2, 2](in CSR)). In other examples, a 1-bit BSS flag in the user field may indicate the BSS. In examples where the common preamble does not provide for joint LTF, in each (M)RU that is in C-SR mode, if there is only one STA served by one AP, the user field may use the non-MU-MIMO user field format. If there is more than one STA served by one AP, the user fields may use the MU-MIMO user field format and the total number of users and spatial configuration subfield are interpreted based on the number of users served by that AP and not include the number of users served by the other AP. In examples where the common preamble does provide for joint LTF, in each (M)RU that is in C-SR mode, STAs served by the two APs may correspond to MU-MIMO users occupying different spatial streams and the user fields may always use the MU-MIMO user field format.

In some aspects, the RU allocation subfield encoding for the (M)RUs with MU-MIMO in the C-SR mode, the values corresponding to the same (M)RU with MU-MIMO may be used to jointly indicate the number of users (and user fields) in the sharing BSS and that in the shared BSS, as well as the ordering of the user fields in terms if the user fields for the sharing BSS are before or after those for the shared BSS. For example, 8 values may be used to indicate different combinations of users [N_user_sharing_BSS, N_user_shared_BSS, the user fields of which BSS are first]. As an example, the 8 values may be: [1, 1, sharing BSS first] to indicate 1 user field for the sharing BSS followed by 1 user field for the shared BSS, [1, 2, sharing BSS first] to indicate 1 user field for the sharing BSS followed by 2 user fields for the shared BSS, [2, 1, sharing BSS first] to indicate 2 user fields for the sharing BSS followed by 1 user field for the shared BSS, [2, 2, sharing BSS first] to indicate 2 user fields for the sharing BSS followed by 2 user fields for the shared BSS, [1, 1, shared BSS first] to indicate 1 user field for the shared BSS followed by 1 user field for the sharing BSS, [1, 2, shared BSS first] to indicate 2 user fields for the shared BSS followed by 1 user field for the sharing BSS, [2, 1, shared BSS first] to indicate 1 user field for the shared BSS followed by 2 user fields for the sharing BSS, and [2, 2, shared BSS first] to indicate 2 user fields for the shared BSS followed by 2 user fields for the sharing BSS.

As an alternative, the values corresponding to the same (M)RU with MU-MIMO may be used to jointly indicate the combinations of the total number of users (across both sharing and shared BSSs) and the number of users in the sharing BSS, as well as the ordering of the user fields in terms if the user fields for the sharing BSS are before or after those for the shared BSS: [N_total_user_across_two_BSSs, N_user_sharing_BSS, the user fields of which BSS are first]. As an example, the 8 values may be: [2, 1, sharing BSS first] to indicate total 2 user fields including 1 user field for the sharing BSS followed by 1 user field for the shared BSS, [3, 1, sharing BSS first] to indicate total 3 user fields including 1 user field for the sharing BSS followed by 2 user fields for the shared BSS, [3, 2, sharing BSS first] to indicate total 3 user fields including 2 user fields for the sharing BSS followed by 1 user field for the shared BSS, [4, 2, sharing BSS first] to indicate total 4 user fields including 2 user fields for the sharing BSS followed by 2 user fields for the shared BSS, [2, 1, shared BSS first] to indicate total 2 user fields including 1 user field for the shared BSS followed by 1 user field for the sharing BSS, [3, 1, shared BSS first] to indicate total 3 user fields including 2 user fields for the shared BSS followed by 1 user field for the sharing BSS, [3, 2, shared BSS first] to indicate total 3 user fields including 1 user field for the shared BSS followed by 2 user fields for the sharing BSS, and [4, 2, shared BSS first] to indicate total 4 user fields including 2 user fields for the shared BSS followed by 2 user fields for the sharing BSS. This approach may only be applicable to DL OFDMA transmissions.

In some examples, when the C-SR indication is provided in U-SIG, the CoBF and interference mitigation (IM) may also be indicated, frequency domain (FD) unequal modulation (UEQM) may also be indicated, and vendor specific signaling may also be indicated. The use cases of C-SR, COBF, IM, and FD UEQM may be mutually exclusive, and none of them may enable spatial reuse (SR). In some examples, separate 1-bit fields may be used to indicate each feature. For example, there are two Validate bits in U-SIG-2 that may be available to indicate C-SR and COBF, separately, and the indication of IM and FD UEQM may use other Disregard or Validate bits in the U-SIG or UHR-SIG common field, or may use Disregard bits or a Validate bit in U-SIG-1 in the case of both C-SR is OFF and COBF is OFF. In other examples, a field with a few bits may be used to choose a single feature. For example, a 2-bit field in U-SIG or UHR-SIG Common field may be used to indicate {No advanced feature ON, C-SR ON, COBF ON, IM ON}. For another example, a 3-bit field in U-SIG or UHR-SIG Common field may be used to indicate {No advanced feature ON, C-SR ON, COBF ON, IM ON, FD UEQM ON, Vender Specific signaling ON}. In further examples, C-SR/COBF may be jointly indicated in U-SIG and further differentiated in UHR-SIG Common field. For example, a 1-bit field in U-SIG may be used to indicate {No C-SR/COBF, Either C-SR or COBF ON}, and another 1-bit field in U-SIG or UHR-SIG Common field may be used to indicate {CSR, CoBF} in the case of ‘Either CSR or CoBF ON,’ and IM, FD UEQM and Vendor Specific signaling may be indicated as described above.

FIGS. 6A and 6B show examples of channel sounding techniques 600 and 650 that support coordinated spatial reuse in Wi-Fi. The channel sounding techniques 600 and 650 include a first AP 602, a second AP 612, a first STA 604 that communicates with the first AP 602, and a second STA 614 that communicates with the second AP 612. The first AP 602, second AP 612, first STA 604, and second STA 614 may be examples of the APs and STAs as described herein with respect to FIGS. 1-5. The channel sounding techniques 600 and 650 illustrate example operations and signaling for a measurement phase of the C-SR transmission mode or COBF transmission mode.

As described herein, the wireless communication devices may implement a framework for selection and utilization of a transmission mode from a COBF transmission mode or a C-SR transmission mode. The transmission modes may be used to determine when and how to share resources with other APs and when not to share such resources. To determine whether to share resources in accordance with the C-SR transmission mode, clients (such as the first STA 604 and the second STA 614) may use one or more measurements, such as CSI or CQI measurements reported by the first STA 604 and/or the second STA 614. The measurement phase of the coordinated communication techniques also may be referred to as a channel sounding phase. In the example of FIG. 6A, channel sounding technique 600 may include multiple phases, including phase 1 where the first STA 604 provides measurement information to the first AP 602, and phase 2 where the second STA 614 provides measurement information to the second AP 612 using the same sequence of signaling as in phase 1.

In this example, the first AP 602 may transmit a null data packet announcement (NDPA) 616. In response to the NDPA 616, and the first AP 602 may transmit a null data packet (NDP) 618 followed by a beamforming report poll trigger frame (BFRP) 620. The first STA 604 may transmit a CSI report 622. The first AP 602 may transmit a NDPA 624, and the second AP 612 may transmit NDP 625. The first AP 602 may transmit a BFRP 628, and the first STA 604 may transmit a CQI report 630. As indicated, phase 2 of the channel sounding may include a same sequence for the second AP 612 such that the second STA 614 provides the CSI and CQI reports. Each CSI and CQI is intended for both APs. Thus, phase 1 provides a CSI to the first AP 602 from first STA 604 and interference feedback (such as a CQI feedback) to the second AP 612 from the first STA 604, and phase 2 provides CSI to the second AP 612 from the second STA 614 and interference feedback (such as a CQI feedback) to the first AP 602 from the second STA 614. In the example of FIG. 6B, the channel sounding technique 650 may include an NDPA 652 transmitted by the first AP 602, a NDP 654 transmitted by the second AP 612, a BFRP 656 transmitted by the first AP 602, and a CQI report 658 transmitted by the first STA 604.

In some examples, in the NDPA 624, it may be indicated that this is a C-SR measurement which requires only CQI feedback from OBSS STAs. In some examples, phase 1 or phase 2 may be turned off in cases of asymmetric C-SR. In some examples, in-BSS CSI collection (such as in the first half of phase 1 and phase 2) may not be needed if in-BSS is not beamformed, and only cross-BSS CQI may be collected. In further examples, the second NDP in phase 1 or phase 2 may only need one LTF or one spatial stream, and it may also be any non-HT frame or any short packet which is efficient.

In some examples, the channel sounding technique 650 may provide cross-BSS CQI feedback, for CQI collection for interference level feedback that may be used to determine a C-SR or COBF transmission mode. In some examples, CQI feedback for C-SR may provide an interference level to the interfering AP. In some examples, the CQI feedback may be sub-band based CQI, or may be whole band CQI (averaged across the entire band). In other examples, CQI may be provided with respect to a bandwidth resolution, such as on a per-20 MHz or per-80 MHz basis. In some aspects, the CQI may be an open loop CQI metric. In some examples, a packet used for open loop CQI calculation does not need to have multiple spatial streams, and a single LTF may be sufficient for CQI calculation at the STA, and any non-high throughput (HT) frame can be used for this. In some examples, an indication of a pre-processing SNR (a measure of signal strength) may be calculated, and may be estimated from a repeated LTF, or may be a calculated noise floor over a longer term from the signal strength from the LTFs. This C-SR CQI maybe different from past CQI metrics and maybe defined as a separate feedback type, which may be requested in addition to regular SU or MU feedback.

As discussed with reference to FIGS. 5A and 5B, a trigger frame may be used to initiate concurrent PPDU transmissions. In some aspects, the trigger frame may be a C-SR trigger that may indicate the STAs being served by the first AP. In some examples, the trigger frame may indicate a modulation and coding scheme (MCS), error vector magnitude (EVM), or interference threshold at the STAs being served by the first AP that may be needed to support concurrent PPDU transmissions. Additionally, in some examples the trigger frame may also specify information to control the second AP transmit power or power backoff. In some examples, the transmit power of the APs may be indicated as a power of the first AP for incumbent transmission, and the power of the second AP (in such examples, a STA list of the second AP may not be needed). In some examples, this power quantity may be defined according to a bandwidth resolution, such as per-20 MHz power. In some examples, instead of exchanging absolute power numbers, relative information may be provided, such as a backoff from a power spectral density (PSD) level at which the pathloss measurement packet was sent (e.g., NDP; beacon), and in the trigger frame the first AP may signal a power backoff for itself and for the second AP. In some examples, the trigger frame may also contain a token or ID to identify the reference frame associated with the power backoff, if the measurement is not based on a previous sounding but on a particular reference frame. Such a backoff may be a smaller number than an absolute power, and thus consume less overhead to provide a smaller range (less bits). Further, absolute power numbers maybe not be known at an AP, and may be a function of the measurement bandwidth. A backoff number may be defined with respect to PSD of a measurement packet to make it bandwidth agnostic. Additionally, it may be difficult for an AP to predict the transmission bandwidth of the OBSS AP, so absolute power may be difficult to calculate, while a power backoff is with respect to a reference frame where interference level was measured. Further, devices do not need to reveal their transmit powers in frames.

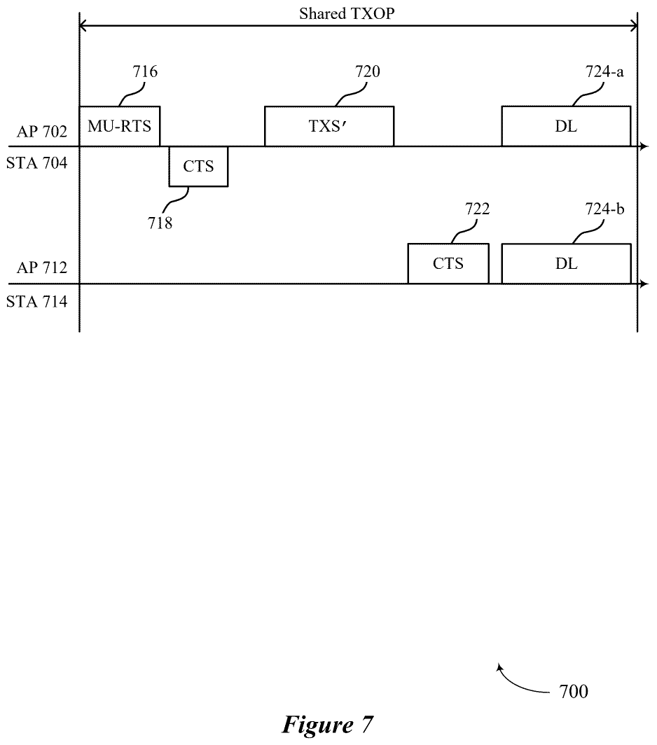

FIG. 7 shows another example of a signaling diagram 700 that supports coordinated spatial reuse in Wi-Fi. The signaling diagram 700 includes a first AP 702, a second AP 712, a first STA 704 that communicates with the first AP 702, and a second STA 714 that communicates with the second AP 712. The first AP 702, second AP 712, first STA 704, and second STA 714 may be examples of the APs and STAs as described herein with respect to FIGS. 1-6. The signaling diagram 700 illustrates example operations and signaling for a measurement phase and coordination phase of the C-SR transmission mode or COBF transmission mode.

As described herein, the wireless communication devices may implement a framework for selection and utilization of a transmission mode from a COBF transmission mode or a C-SR transmission mode. The transmission modes may be used to determine when and how to share resources with other APs and when not to share such resources. In this example, a MU RTS/CTS exchange prior to a first downlink PPDU 724-a and a second downlink PPDU 724-b transmission is shown. The MU RTS/CTS exchange may include a MU-RTS 716, followed by a CTS 718 from the first STA 704. The first AP 702 may transmit a TXS' frame 720, and the second AP 712 may optionally transmit CTS 722, after which the first downlink PPDU 724-a and a second downlink PPDU 724-b may be concurrently transmitted.

In order to determine transmit powers, the RTS/CTS may be used. For example, at the first STA 704, a signal to interference radio (SIR) value at the first STA 704 may correspond to a transmit power (T₁) of the first AP 702 less a pathloss (PL₁) between the first AP 702 and the first STA 704, minus a transmit power (T₂) of the second AP 712 less a pathloss (PL₂) between the second AP 712 and the first STA 704. Thus:

$$S I R = ( {T}_{1} - P {L}_{1} ) - ( {T}_{2} - P {L}_{2} )$$

where the first AP 702 knows the required SIR to serve the first STA 704 at a desired MCS. So, the first AP 702 may calculate a maximum allowed downlink transmit power (T₂) from the second AP 712 as follows:

$${T}_{2} = ( {T}_{1} - S I R ) + ( {PL}_{2} - {PL}_{1} ) .$$

Both the first AP 702 and the second AP 712 measure the receive power level of the CTS 718 (C₁ and C₂, respectively) sent by the first STA 704 in response to the MU-RTS 716 frame sent by the first AP 702, where C₁ is the receive power of the CTS 718 measured at the first AP 702 and C₂ is the receive power of the CTS 718 measured at the second AP 712, such that:

$${C}_{1} - {C}_{2} = ( {T}_{CTS} - {PL}_{1} ) - ( {T}_{CTS} - {PL}_{2} ) = {PL}_{2} - {PL}_{1}$$

where TC_{T}S is the transmit power of CTS 718. The second AP 712 may compute T₂=(T₁−SIR)+(C₁−C₂) as follows:
The first AP 702 sends in the TXS' frame the allocation duration and the C-SR parameters (T₁−SIR+C₁) in the form of three parameters (T₁, SIR, C₁), two parameters such as (T₁−SIR, C₁) or (T₁+C₁, SIR), or one parameter (T₁−SIR+C₁) so that the second AP 712 can compute T₂ based on measured C₂.
The second AP 712 may send CTS only if it intends to send a re-use transmission. TXS' may include additional padding to allow for the second AP 712 to check if it can meet T₂ and prepare response (CTS and/or PPDU)
The first AP 702 may schedule another AP if it does not receive CTS from the second AP 712.
   Thus, the transmit power for the second AP 712 may be computed and used for the transmission of the second downlink PPDU 724-b.

In some aspects, the TXS' frame 720 may serve as a coordinated transmission trigger frame, such as a C-SR trigger. In some examples, the TXS' frame 720 may list the STAs being served by the first AP 702, and may indicate a MCS/EVM/Interference threshold at the STAs being served by the first AP 702 that may be needed for concurrent transmissions in the shared TXOP. In some examples, the TXS' frame 720 may include a bit that indicates that the measurement reference is the previous RTS-CTS exchange. In some examples, the TXS' frame 720 may reuse a token/ID subfield to identify the reference frame for this indication. Further, in some examples, the TXS' frame 720 may specify information to control the shared AP transmission power, that may be used for identification of the quantity T₁−SIR+C₁, either as a single number or split into multiple quantities, such as two quantities of (T₁−SIR, C₁) or (T₁+C₁, SIR) or three quantities of (T₁, SIR, C₁). In some examples, this quantity is split into two quantities to indicate the transmit power associated with each AP, and a flag may be set to indicate the RTS-CTS based operation. The quantity T₁−SIR+C₁, or each of the two quantities or each of the three quantities, may be defined according to a bandwidth resolution, such as per-20 MHz power.

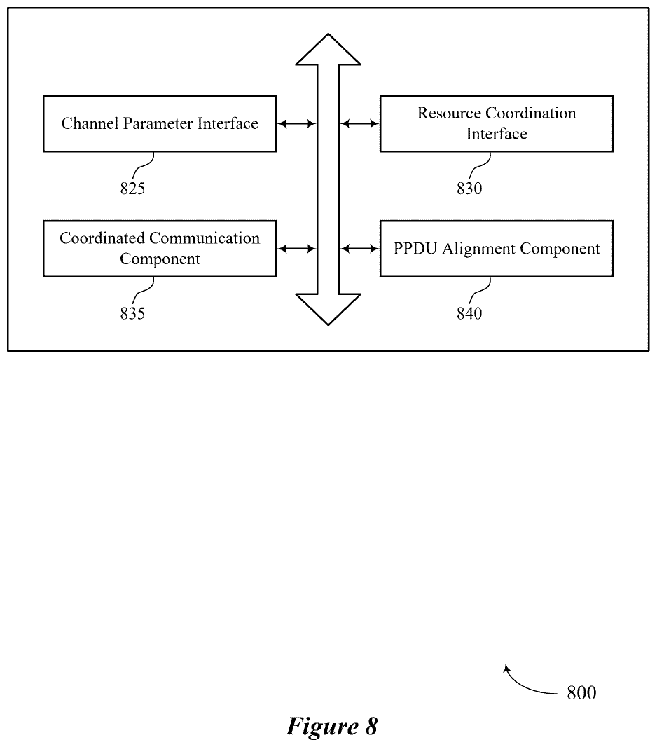

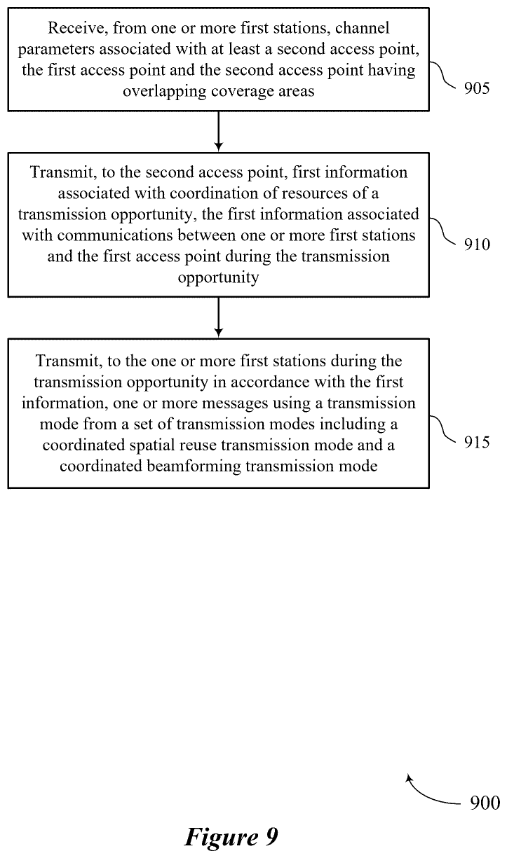

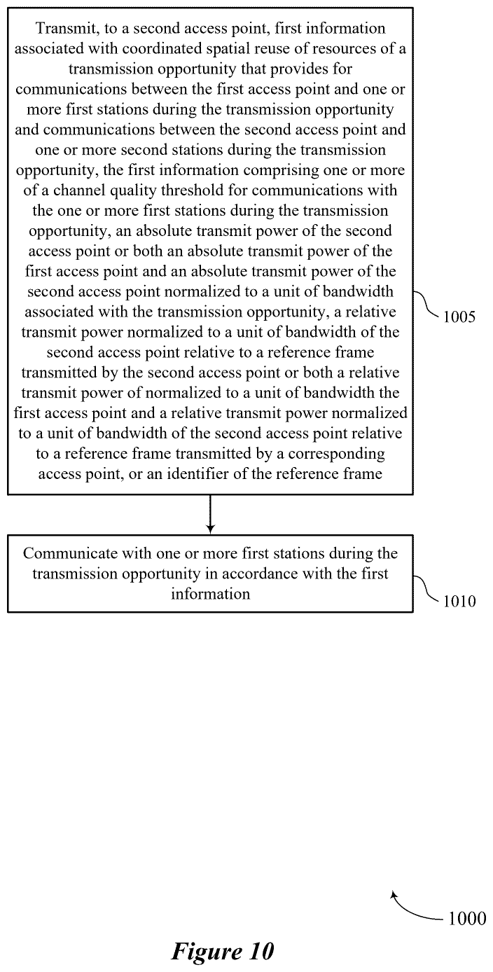

FIG. 8 shows a block diagram of an example wireless communication device 800 that supports coordinated spatial reuse in Wi-Fi. In some examples, the wireless communication device 800 is configured to perform the processes 900 and 1000 described with reference to FIGS. 9 and 10, respectively. The wireless communication device 800 may include one or more chips, SoCs, chipsets, packages, components or devices that individually or collectively constitute or include a processing system. The processing system may interface with other components of the wireless communication device 800, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 800 may transmit the information output from the chip. In such an example, the second interface may refer to an interface between the processing system of the chip and a reception component, such that the wireless communication device 800 may receive information that is then passed to the processing system. In some such examples, the first interface also may obtain information, such as from the transmission component, and the second interface also may output information, such as to the reception component.

The processing system of the wireless communication device 800 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 800 can be configurable or configured for use in an AP, such as the AP 102 described with reference to FIG. 1. In some other examples, the wireless communication device 800 can be an AP that includes such a processing system and other components including multiple antennas. The wireless communication device 800 is capable of transmitting and receiving wireless communications in the form of, for example, wireless packets. For example, the wireless communication device 800 can be configurable or configured to transmit and receive packets in the form of physical layer PPDUs and MPDUs conforming to one or more of the IEEE 802.11 family of wireless communication protocol standards. In some other examples, the wireless communication device 800 can be configurable or configured to transmit and receive signals and communications conforming to one or more 3GPP specifications including those for 5G NR or 6G. In some examples, the wireless communication device 800 also includes or can be coupled with one or more application processors which may be further coupled with one or more other memories. In some examples, the wireless communication device 800 further includes at least one external network interface coupled with the processing system that enables communication with a core network or backhaul network that enables the wireless communication device 800 to gain access to external networks including the Internet.

The wireless communication device 800 includes a channel parameter interface 825, a resource coordination interface 830, a coordinated communication component 835, and a PPDU alignment component 840. Portions of one or more of the channel parameter interface 825, the resource coordination interface 830, the coordinated communication component 835, and the PPDU alignment component 840 may be implemented at least in part in hardware or firmware. For example, one or more of the channel parameter interface 825, the resource coordination interface 830, the coordinated communication component 835, and the PPDU alignment component 840 may be implemented at least in part by at least a processor or a modem. In some examples, portions of one or more of the channel parameter interface 825, the resource coordination interface 830, the coordinated communication component 835, and the PPDU alignment component 840 may be implemented at least in part by a processor and software in the form of processor-executable code stored in memory.

The wireless communication device 800 may support wireless communications in accordance with examples as disclosed herein. The channel parameter interface 825 is configurable or configured to receive, from one or more first stations, channel parameters associated with at least a second access point, the first access point and the second access point having overlapping coverage areas. The resource coordination interface 830 is configurable or configured to transmit, to the second access point, first information associated with coordination of resources of a transmission opportunity, the first information associated with communications between one or more first stations and the first access point during the transmission opportunity. The coordinated communication component 835 is configurable or configured to transmit, to the one or more first stations during the transmission opportunity in accordance with the first information, one or more messages using a transmission mode from a set of transmission modes including a coordinated spatial reuse transmission mode and a coordinated beamforming transmission mode.

In some examples, the first information comprises one or more first identifiers associated with communications between one or more first stations and the first access point during the transmission opportunity, and one or more second identifiers are different than one or more first identifiers, the one or more second identifiers associated with communications between one or more second stations and the second access point during the transmission opportunity, and the coordinated communication component 835 is configurable or configured to receive, from the second access point, second information associated with the coordination of the resources that indicates whether the second access point can communicate with the one or more second stations during the transmission opportunity in accordance with the first information. In some examples, one or more channel condition reports are based on a bandwidth resolution associated with transmissions of the second access point received from the one or more first stations.

In some examples, the coordinated communication component 835 is configurable or configured to transmit a first message of a coordinated sounding procedure. In some examples, the coordinated communication component 835 is configurable or configured to receive sounding feedback associated with the second access point responsive to the first message. In some examples, the coordinated communication component 835 is configurable or configured to select, in accordance with the sounding feedback, a multi-access point coordination scheme for use by the first access point and the second access point during the transmission opportunity, the multi-access point coordination scheme selected from a coordinated beamforming (COBF) scheme, a coordinated spatial reuse (C-SR) scheme, or a joint transmission (JT) scheme. In some examples, the coordinated communication component 835 is configurable or configured to transmit one or more subsequent messages for one or more subsequent coordinated sounding procedures that provide updated feedback associated with the second access point.

In some examples, the coordinated communication component 835 is configurable or configured to transmit a first message of an open-loop feedback request to the one or more first stations. In some examples, the coordinated communication component 835 is configurable or configured to receive an open-loop channel quality indicator (CQI) report associated with the first message from the one or more first stations. In some examples, the first message includes a single spatial stream, or includes multiple spatial streams.

Additionally, or alternatively, the wireless communication device 800 may support wireless communications in accordance with examples as disclosed herein. In some examples, the channel parameter interface 825 is configurable or configured to transmit, to a second access point, first information associated with coordinated spatial reuse of resources of a transmission opportunity that provides for communications between the first access point and one or more first stations during the transmission opportunity and communications between the second access point and one or more second stations during the transmission opportunity, the first information comprising one or more of a channel quality threshold for communications with the one or more first stations during the transmission opportunity, an absolute transmit power of the second access point or both an absolute transmit power of the first access point and an absolute transmit power of the second access point normalized to a unit of bandwidth associated with the transmission opportunity, a relative transmit power normalized to a unit of bandwidth of the second access point relative to a reference frame transmitted by the second access point or both a relative transmit power of normalized to a unit of bandwidth the first access point and a relative transmit power normalized to a unit of bandwidth of the second access point relative to a reference frame transmitted by a corresponding access point, or an identifier of the reference frame. In some examples, the coordinated communication component 835 is configurable or configured to communicate with one or more first stations during the transmission opportunity in accordance with the first information.

In some examples, the channel quality threshold includes one or more of a modulation and coding scheme (MCS), an error vector magnitude (EVM), or an interference threshold for communications with the one or more first stations during the transmission opportunity. In some examples, the absolute transmit power is a quantity associated with a bandwidth that is a portion of a total bandwidth associated with the transmission opportunity. In some examples, the relative transmit power indicates a power backoff from a power spectral density level at which a prior packet or physical layer protocol data unit is transmitted by the first access point. In some examples, the identifier of the reference frame is a token or an identification value associated with the reference frame.

In some examples, the first information indicates that the reference frame is associated with a previous ready-to-send (RTS) and clear-to-send (CTS) exchange between the first access point and the one or more first stations. In some examples, the first information includes an indication of a first quantity associated with an interference level at the first access point.

Additionally, or alternatively, the wireless communication device 800 may support wireless communications in accordance with examples as disclosed herein. The PPDU alignment component 840 is configurable or configured to transmit, to a second access point, first information associated with coordination of resources of a transmission opportunity, the first information comprising one or more alignment parameters for concurrent transmissions of at least a first physical layer protocol data unit (PPDU) from the first access point and a second PPDU from the second access point during the transmission opportunity, and the first access point and the second access point having overlapping coverage areas. In some examples, the coordinated communication component 835 is configurable or configured to communicate with one or more stations during the transmission opportunity in accordance with the first information.

In some examples, the first information is transmitted in a transmission opportunity duration announcement associated with a coordinated spatial reuse (C-SR) invite frame or a C-SR trigger frame. In some examples, the PPDU alignment component 840 is configurable or configured to receive, from the second access point, second information that indicates one or more timing parameters for the concurrent transmissions of PPDUs, and where communications with the one or more stations are in accordance with the first information and the second information. In some examples, the first PPDU and the second PPDU each share a common preamble up to a legacy signal (L-SIG) field, the common preamble transmitted from each of the first access point and the second access point during the transmission opportunity, and where the first information further indicates a value of a LENGTH subfield of the L-SIG field. In some examples, the first PPDU and the second PPDU each share a common preamble up to an ultra-high reliability signal (UHR-SIG) field, the common preamble transmitted from each of the first access point and the second access point during the transmission opportunity. In some examples, the first PPDU and the second PPDU each share a common preamble up to an ultra-high reliability long training field (UHR-LTF), the common preamble transmitted from each of the first access point and the second access point during the transmission opportunity.

In some examples, the first PPDU and the second PPDU each indicate a same basic service set (BSS) color. In some examples, a universal signal (U-SIG) field of the first PPDU and the second PPDU includes one or more of an indication that the first PPDU and the second PPDU are transmitted in accordance with coordinated spatial reuse (C-SR) procedures, and an indication of a basic service set (BSS) color of the second access point. In some examples, the first access point and the second access point use a same compression mode for communications during the transmission opportunity. In some examples, the first access point uses a first compression mode during the transmission opportunity that is different than a second compression mode used by the second access point, and where a PPDU preamble of the first PPDU and the second PPDU includes separate compression mode subfields that indicate the first compression mode and the second compression mode.

In some examples, a universal signal (U-SIG) field of the first PPDU and the second PPDU includes a coordinated spatial reuse (C-SR) indication that the first PPDU and the second PPDU are transmitted in accordance with C-SR procedures, and where the C-SR indication is provided in separate subfields of the U-SIG field, or is provided in a single multi-bit subfield of the U-SIG field. In some examples, the first information includes an indication that the concurrent transmissions of the first PPDU and the second PPDU are in accordance with a coordinated spatial reuse procedure or a coordinated beamforming procedure, and where the indication is jointly provided by two or more subfields in the first information.

FIG. 9 shows a flowchart illustrating an example process 900 performable by or at a first access point that supports coordinated spatial reuse in Wi-Fi. The operations of the process 900 may be implemented by a first access point or its components as described herein. For example, the process 900 may be performed by a wireless communication device, such as the wireless communication device 800 described with reference to FIG. 8, operating as or within a wireless AP. In some examples, the process 900 may be performed by a wireless AP, such as one of the APs 102 described with reference to FIG. 1.

In some examples, in 905, the first access point may receive, from one or more first stations, channel parameters associated with at least a second access point, the first access point and the second access point having overlapping coverage areas. The operations of 905 may be performed in accordance with examples as disclosed herein. In some implementations, aspects of the operations of 905 may be performed by a channel parameter interface 825 as described with reference to FIG. 8.

In some examples, in 910, the first access point may transmit, to the second access point, first information associated with coordination of resources of a transmission opportunity, the first information associated with communications between one or more first stations and the first access point during the transmission opportunity. The operations of 910 may be performed in accordance with examples as disclosed herein. In some implementations, aspects of the operations of 910 may be performed by a resource coordination interface 830 as described with reference to FIG. 8.

In some examples, in 915, the first access point may transmit, to the one or more first stations during the transmission opportunity in accordance with the first information, one or more messages using a transmission mode from a set of transmission modes including a coordinated spatial reuse transmission mode and a coordinated beamforming transmission mode. The operations of 915 may be performed in accordance with examples as disclosed herein. In some implementations, aspects of the operations of 915 may be performed by a coordinated communication component 835 as described with reference to FIG. 8.

FIG. 10 shows a flowchart illustrating an example process 1000 performable by or at a first access point that supports coordinated spatial reuse in Wi-Fi. The operations of the process 1000 may be implemented by a first access point or its components as described herein. For example, the process 1000 may be performed by a wireless communication device, such as the wireless communication device 800 described with reference to FIG. 8, operating as or within a wireless AP. In some examples, the process 1000 may be performed by a wireless AP, such as one of the APs 102 described with reference to FIG. 1.

In some examples, in 1005, the first access point may transmit, to a second access point, first information associated with coordinated spatial reuse of resources of a transmission opportunity that provides for communications between the first access point and one or more first stations during the transmission opportunity and communications between the second access point and one or more second stations during the transmission opportunity, the first information comprising one or more of a channel quality threshold for communications with the one or more first stations during the transmission opportunity, an absolute transmit power of the second access point or both an absolute transmit power of the first access point and an absolute transmit power of the second access point normalized to a unit of bandwidth associated with the transmission opportunity, a relative transmit power normalized to a unit of bandwidth of the second access point relative to a reference frame transmitted by the second access point or both a relative transmit power of normalized to a unit of bandwidth the first access point and a relative transmit power normalized to a unit of bandwidth of the second access point relative to a reference frame transmitted by a corresponding access point, or an identifier of the reference frame. The operations of 1005 may be performed in accordance with examples as disclosed herein. In some implementations, aspects of the operations of 1005 may be performed by a channel parameter interface 825 as described with reference to FIG. 8.

In some examples, in 1010, the first access point may communicate with one or more first stations during the transmission opportunity in accordance with the first information. The operations of 1010 may be performed in accordance with examples as disclosed herein. In some implementations, aspects of the operations of 1010 may be performed by a coordinated communication component 835 as described with reference to FIG. 8.

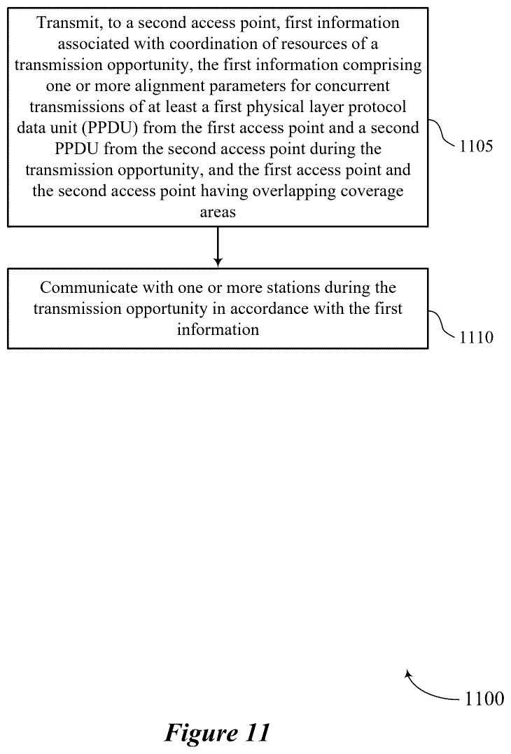

FIG. 11 shows a flowchart illustrating an example process 1100 performable by or at a first access point that supports coordinated spatial reuse in Wi-Fi. The operations of the process 1100 may be implemented by a first access point or its components as described herein. For example, the process 1100 may be performed by a wireless communication device, such as the wireless communication device 800 described with reference to FIG. 8, operating as or within a wireless AP. In some examples, the process 1100 may be performed by a wireless AP, such as one of the APs 102 described with reference to FIG. 1.

In some examples, in 1105, the first access point may transmit, to a second access point, first information associated with coordination of resources of a transmission opportunity, the first information including one or more alignment parameters for concurrent transmissions of at least a first physical layer protocol data unit (PPDU) and a second PPDU from the first access point and the second access point during the transmission opportunity, and the first access point and the second access point having overlapping coverage areas. The operations of 1105 may be performed in accordance with examples as disclosed herein. In some implementations, aspects of the operations of 1105 may be performed by a PPDU alignment component 840 as described with reference to FIG. 8.

In some examples, in 1110, the first access point may communicate with one or more stations during the transmission opportunity in accordance with the first information. The operations of 1110 may be performed in accordance with examples as disclosed herein. In some implementations, aspects of the operations of 1110 may be performed by a coordinated communication component 835 as described with reference to FIG. 8.

Implementation examples are described in the following numbered clauses:
Clause 1: A method for wireless communications at a first access point, comprising: receiving, from one or more first stations, channel parameters associated with at least a second access point, the first access point and the second access point having overlapping coverage areas; transmitting, to the second access point, first information associated with coordination of resources of a transmission opportunity, the first information associated with communications between one or more first stations and the first access point during the transmission opportunity; and transmitting, to the one or more first stations during the transmission opportunity in accordance with the first information, one or more messages using a transmission mode from a set of transmission modes comprising a coordinated spatial reuse transmission mode and a coordinated beamforming transmission mode.
Clause 2: The method of clause 1, wherein the first information comprises one or more first identifiers associated with communications between one or more first stations and the first access point during the transmission opportunity, and one or more second identifiers are different than one or more first identifiers, the one or more second identifiers associated with communications between one or more second stations and the second access point during the transmission opportunity, and wherein the method further comprises: receiving, from the second access point, second information associated with the coordination of the resources that indicates whether the second access point can communicate with the one or more second stations during the transmission opportunity in accordance with the first information.
Clause 3: The method of any of clauses 1 through 2, wherein the channel parameters comprise one or more channel condition reports that include a cross-BSS channel measurement based on a bandwidth resolution associated with transmissions of the second access point received from the one or more first stations.
Clause 4: The method of any of clauses 1 through 3, further comprising: transmitting a first message of a coordinated sounding procedure; receiving sounding feedback for a cross-BSS channel link from the second access point to one or more first stations responsive to the first message; and selecting, in accordance with the sounding feedback, a multi-access point coordination scheme for use by the first access point and the second access point during the transmission opportunity, the multi-access point coordination scheme selected from a coordinated beamforming (COBF) scheme, a coordinated spatial reuse (C-SR) scheme, or a joint transmission (JT) scheme.
Clause 5: The method of clause 4, further comprising: transmitting one or more subsequent messages for one or more subsequent coordinated sounding procedures that provide updated cross-BSS channel link feedback associated with the second access point.
Clause 6: The method of any of clauses 1 through 5, further comprising: transmitting a first message of an open-loop feedback request to the one or more first stations; and receiving an open-loop channel quality indicator (CQI) report associated with the first message from the one or more first stations.
Clause 7: The method of clause 6, wherein the first message includes a single spatial stream, or includes multiple spatial streams.
Clause 8: A method for wireless communications at a first access point, comprising: transmitting, to a second access point, first information associated with coordinated spatial reuse of resources of a transmission opportunity that provides for communications between the first access point and one or more first stations during the transmission opportunity and communications between the second access point and one or more second stations during the transmission opportunity, the first information comprising one or more of a channel quality threshold for communications with the one or more first stations during the transmission opportunity, an absolute transmit power of the second access point or both an absolute transmit power of the first access point and an absolute transmit power of the second access point normalized to a unit of bandwidth associated with the transmission opportunity, a relative transmit power normalized to a unit of bandwidth of the second access point relative to a reference frame transmitted by the second access point or both a relative transmit power of normalized to a unit of bandwidth the first access point and a relative transmit power normalized to a unit of bandwidth of the second access point relative to a reference frame transmitted by a corresponding access point, or an identifier of the reference frame; and communicating with one or more first stations during the transmission opportunity in accordance with the first information.
Clause 9: The method of clause 8, wherein the channel quality threshold comprises one or more of a modulation and coding scheme (MCS), an error vector magnitude (EVM), or an interference threshold for communications with the one or more first stations during the transmission opportunity.
Clause 10: The method of any of clauses 8 through 9, wherein the absolute transmit power is a quantity associated with a bandwidth that is a portion of a total bandwidth associated with the transmission opportunity.
Clause 11: The method of any of clauses 8 through 10, wherein the relative transmit power indicates a power backoff from a power spectral density level at which a prior packet or physical layer protocol data unit is transmitted by the first access point.
Clause 12: The method of any of clauses 8 through 11, wherein the identifier of the reference frame is a token or an identification value associated with the reference frame.
Clause 13: The method of any of clauses 8 through 12, wherein the first information indicates that the reference frame is associated with a previous ready-to-send (RTS) and clear-to-send (CTS) exchange between the first access point and the one or more first stations.
Clause 14: The method of clause 13, wherein the first information includes an indication of a first quantity associated with an interference level at the first access point.
Clause 15: A method for wireless communications at a first access point, comprising: transmitting, to a second access point, first information associated with coordination of resources of a transmission opportunity, the first information comprising one or more alignment parameters for concurrent transmissions of at least a first physical layer protocol data unit (PPDU) from the first access point and a second PPDU from the second access point during the transmission opportunity, and the first access point and the second access point having overlapping coverage areas; and communicating with one or more stations during the transmission opportunity in accordance with the first information.
Clause 16: The method of clause 15, wherein the first information is transmitted in a transmission opportunity duration announcement associated with a coordinated spatial reuse (C-SR) invite frame or a C-SR trigger frame.
Clause 17: The method of any of clauses 15 through 16, further comprising: receiving, from the second access point, second information that indicates one or more timing parameters for the concurrent transmissions of PPDUs, and wherein communications with the one or more stations are in accordance with the first information and the second information.
Clause 18: The method of any of clauses 15 through 17, wherein the first PPDU and the second PPDU each share a common preamble up to one or more of a legacy signal (L-SIG) field, an ultra-high reliability signal (UHR-SIG) field, or an ultra-high reliability long training field (UHR-LTF), the common preamble transmitted from each of the first access point and the second access point during the transmission opportunity, and wherein the first information further indicates a value of a LENGTH subfield of the L-SIG field.
Clause 19: The method of any of clauses 15 through 18, wherein the first PPDU and the second PPDU each indicate a same basic service set (BSS) color in a universal signal (U-SIG) field.
Clause 20: The method of clause 19, wherein the universal signal (U-SIG) field of the first PPDU and the second PPDU includes one or more of an indication that the first PPDU and the second PPDU are transmitted in accordance with coordinated spatial reuse (C-SR) procedures, and an indication of a basic service set (BSS) color of one or more of the first access point, the second access point, or a group BSS color associated with the first access point and the second access point.
Clause 21: The method of any of clauses 15 through 20, wherein the first access point and the second access point use a same compression mode for communications during the transmission opportunity.
Clause 22: The method of any of clauses 15 through 21, wherein the first access point uses a first compression mode during the transmission opportunity that is different than a second compression mode used by the second access point, and wherein a PPDU preamble of the first PPDU and the second PPDU includes separate compression mode subfields that indicate the first compression mode and the second compression mode.
Clause 23: The method of any of clauses 15 through 22, wherein a universal signal (U-SIG) field of the first PPDU and the second PPDU includes a coordinated spatial reuse (C-SR) indication that the first PPDU and the second PPDU are transmitted in accordance with C-SR procedures, and wherein the C-SR indication is provided in separate subfields of the U-SIG field, or is provided in a single multi-bit subfield of the U-SIG field.
Clause 24: The method of any of clauses 15 through 23, wherein the first information comprises an indication that the concurrent transmissions of the first PPDU and the second PPDU are in accordance with a coordinated spatial reuse procedure or a coordinated beamforming procedure, and wherein the indication is jointly provided by two or more subfields in the first information, or a universal signal (U-SIG) field of the first PPDU and the second PPDU includes a coordinated spatial reuse (C-SR) indication that the first PPDU and the second PPDU are transmitted in accordance with C-SR procedures, and wherein the C-SR indication is provided in separate subfields of the U-SIG field, or is provided in a single multi-bit subfield of the U-SIG field.
Clause 25: A first access point for wireless communications, comprising a processing system that includes processor circuitry and memory circuitry that stores code, the processing system configured to cause the first access point to perform a method of any of clauses 1 through 7.
Clause 26: A first access point for wireless communications, comprising at least one means for performing a method of any of clauses 1 through 7.
Clause 27: A non-transitory computer-readable medium storing code for wireless communications, the code comprising instructions executable by one or more processors to perform a method of any of clauses 1 through 7.
Clause 28: A first access point for wireless communications, comprising a processing system that includes processor circuitry and memory circuitry that stores code, the processing system configured to cause the first access point to perform a method of any of clauses 8 through 14.
Clause 29: A first access point for wireless communications, comprising at least one means for performing a method of any of clauses 8 through 14.
Clause 30: A non-transitory computer-readable medium storing code for wireless communications, the code comprising instructions executable by one or more processors to perform a method of any of clauses 8 through 14.
Clause 31: A first access point for wireless communications, comprising a processing system that includes processor circuitry and memory circuitry that stores code, the processing system configured to cause the first access point to perform a method of any of clauses 15 through 24.
Clause 32: A first access point for wireless communications, comprising at least one means for performing a method of any of clauses 15 through 24.
Clause 33: A non-transitory computer-readable medium storing code for wireless communications, the code comprising instructions executable by one or more processors to perform a method of any of clauses 15 through 24.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first access point, comprising:
a processing system that includes processor circuitry and memory circuitry that stores code, the processing system configured to cause the first access point to:
receive, from one or more first stations, channel parameters associated with at least a second access point, the first access point and the second access point having overlapping coverage areas;
transmit, to the second access point, first information associated with coordination of resources of a transmission opportunity, the first information associated with communications between the one or more first stations and the first access point during the transmission opportunity; and
transmit, to the one or more first stations during the transmission opportunity in accordance with the first information, one or more messages using a transmission mode from a set of transmission modes comprising a coordinated spatial reuse transmission mode and a coordinated beamforming transmission mode.

2. The first access point of claim 1, wherein:
the first information comprises one or more first identifiers associated with communications between the one or more first stations and the first access point during the transmission opportunity, and one or more second identifiers are different than one or more first identifiers, the one or more second identifiers associated with communications between one or more second stations and the second access point during the transmission opportunity, and
the processing system is further configured to cause the first access point to receive, from the second access point, second information associated with the coordination of the resources that indicates whether the second access point can communicate with the one or more second stations during the transmission opportunity in accordance with the first information.

3. The first access point of claim 1, wherein the channel parameters comprise one or more channel condition reports that include a cross-BSS channel measurement based on a bandwidth resolution associated with transmissions of the second access point received from the one or more first stations.

4. The first access point of claim 1, wherein the processing system is further configured to cause the first access point to:
transmit a first message of a coordinated sounding procedure;
receive sounding feedback for a cross-BSS channel link from the second access point to one or more first stations responsive to the first message; and
select, in accordance with the sounding feedback, a multi-access point coordination scheme for use by the first access point and the second access point during the transmission opportunity, the multi-access point coordination scheme selected from a coordinated beamforming (COBF) scheme, a coordinated spatial reuse (C-SR) scheme, or a joint transmission (JT) scheme.

5. The first access point of claim 4, wherein the processing system is further configured to cause the first access point to transmit one or more subsequent messages for one or more subsequent coordinated sounding procedures that provide updated cross-BSS channel link feedback associated with the second access point.

6. A first access point, comprising:
a processing system that includes processor circuitry and memory circuitry that stores code, the processing system configured to cause the first access point to:
transmit, to a second access point, first information associated with coordinated spatial reuse of resources of a transmission opportunity that provides for communications between the first access point and one or more first stations during the transmission opportunity and communications between the second access point and one or more second stations during the transmission opportunity, the first information comprising one or more of a channel quality threshold for communications with the one or more first stations during the transmission opportunity, an absolute transmit power of the second access point or both an absolute transmit power of the first access point and an absolute transmit power of the second access point normalized to a unit of bandwidth associated with the transmission opportunity, a relative transmit power normalized to a unit of bandwidth of the second access point relative to a reference frame transmitted by the second access point or both a relative transmit power of normalized to a unit of bandwidth the first access point and a relative transmit power normalized to a unit of bandwidth of the second access point relative to a reference frame transmitted by a corresponding access point, or an identifier of the reference frame; and
communicate with one or more first stations during the transmission opportunity in accordance with the first information.

7. The first access point of claim 6, wherein the channel quality threshold comprises one or more of a modulation and coding scheme (MCS), an error vector magnitude (EVM), or an interference threshold for communications with the one or more first stations during the transmission opportunity.

8. The first access point of claim 6, wherein the absolute transmit power is a quantity associated with a bandwidth that is a portion of a total bandwidth associated with the transmission opportunity.

9. The first access point of claim 6, wherein the relative transmit power indicates a power backoff from a power spectral density level at which a prior packet or physical layer protocol data unit is transmitted by the first access point.

10. The first access point of claim 6, wherein the identifier of the reference frame is a token or an identification value associated with the reference frame.

11. The first access point of claim 6, wherein the first information indicates that the reference frame is associated with a previous ready-to-send (RTS) and clear-to-send (CTS) exchange between the first access point and the one or more first stations.

12. The first access point of claim 11, wherein the first information includes an indication of a first quantity associated with an interference level at the first access point.

13. A first access point, comprising:
a processing system that includes processor circuitry and memory circuitry that stores code, the processing system configured to cause the first access point to:
transmit, to a second access point, first information associated with coordination of resources of a transmission opportunity, the first information comprising one or more alignment parameters for concurrent transmissions of at least a first physical layer protocol data unit (PPDU) from the first access point and a second PPDU from the second access point during the transmission opportunity, and the first access point and the second access point having overlapping coverage areas; and
communicate with one or more stations during the transmission opportunity in accordance with the first information.

14. The first access point of claim 13, wherein the first information is transmitted in a transmission opportunity duration announcement associated with a coordinated spatial reuse (C-SR) invite frame or a C-SR trigger frame.

15. The first access point of claim 13, wherein the processing system is further configured to cause the first access point to receive, from the second access point, second information that indicates one or more parameters for the concurrent transmissions of PPDUs, and wherein communications with the one or more stations are in accordance with the first information and the second information.

16. The first access point of claim 13, wherein the first PPDU and the second PPDU each share a common preamble up to one or more of a legacy signal (L-SIG) field, an ultra-high reliability signal (UHR-SIG) field, or an ultra-high reliability long training field (UHR-LTF), the common preamble transmitted from each of the first access point and the second access point during the transmission opportunity, and wherein the first information further indicates a value of a LENGTH subfield of the L-SIG field.

17. The first access point of claim 13, wherein the first PPDU and the second PPDU each indicate a same basic service set (BSS) color in a universal signal (U-SIG) field.

18. The first access point of claim 17, wherein the universal signal (U-SIG) field of the first PPDU and the second PPDU includes one or more of an indication that the first PPDU and the second PPDU are transmitted in accordance with coordinated spatial reuse (C-SR) procedures, and an indication of a basic service set (BSS) color of one or more of the first access point, the second access point, or a group BSS color associated with the first access point and the second access point.

19. The first access point of claim 13, wherein the first access point and the second access point use a same compression mode for communications during the transmission opportunity.

20. The first access point of claim 13, wherein:
the first information comprises an indication that the concurrent transmissions of the first PPDU and the second PPDU are in accordance with a coordinated spatial reuse procedure or a coordinated beamforming procedure, and wherein the indication is jointly provided by two or more subfields in the first information, or
a universal signal (U-SIG) field of the first PPDU and the second PPDU includes a coordinated spatial reuse (C-SR) indication that the first PPDU and the second PPDU are transmitted in accordance with C-SR procedures, and wherein the C-SR indication is provided in separate subfields of the U-SIG field, or is provided in a single multi-bit subfield of the U-SIG field.
